(19) United States
(12) Patent Application Publication
(10) Pub. No.: US 2011/0197221 A1
(43) Pub. Date: Aug. 11, 2011

(54) AD SELECTION BASED ON PROMOTIONAL COUPON REDEMPTION

(76) Inventors: Alan Rouse, Lawrenceville, GA (US); Charles Dasher, Lawrenceville, GA (US)

(21) Appl. No.: 12/704,222

(22) Filed: Feb. 11, 2010

(51) Int. Cl. H04N 7/00

(52) U.S. Cl. 725/32

(57) ABSTRACT

A cable service provider system provides a subscriber of a cable system access to a program in response to the subscriber entering a coupon code, where the program would otherwise not be viewable, or a discount is provided for viewing the program. The cable system can use the coupon code to then select an advertisement to stream with the program, where the ad is associated with a merchant distributing the coupons. The subscriber provides the coupon code to the cable service provider when selecting a video-on demand program, allowing the subscriber to either receive a discount on a pay-per-view movie, or accessing a program that otherwise would not be accessible. The coupon code can be associated with data identifying the merchant and purchasing history of the viewer, and an Ad Selection system uses that data to select an ad.

### FIELD OF INVENTION

The disclosed invention generally relates to systems and methods for selecting advertisements to be streamed to a cable system television viewer in conjunction with the viewer redeeming an electronic coupon. The coupon allows the viewer to receive a video program that otherwise could not be viewed, or to receive a discount in conjunction with receiving the video program selected by the viewer.

### BACKGROUND OF THE INVENTION

The use of coupons, in general, is well known as a mechanism for promoting certain products. Coupons have been traditionally printed on a paper medium, such as in a newspaper, physically obtained by the consumer and then provided by the consumer to the merchant at the time of sale for a product or service, where a discount is provided to the consumer. Other prior art systems, such as U.S. Pat. No. 5,285,278, discloses an electronic method of transmission of coupons using television signals, where coupons can be locally printed or stored in a recording medium, such as on an magnetically striped card. These types of coupons are used for redeeming discounts for products of other merchants, and not for services offered by a video service provider.

Another prior art system, such as disclosed in U.S. Pat. No. 6,057,872, provides a couponing system for pay television services, but it is based on a loyalty program which rewards viewers of the service provider. In one embodiment, coupons or credits are transmitted to the viewer's set top box and the set top box accrues coupons for that user based on the viewer's viewing habits. These coupons can be redeemed by the viewer for viewing a pay-per-view (“PPV”) program. However, such a system does not provide flexibility in distributing coupons to users, as the coupons are maintained in the viewer's set top box based on the user's viewing habits.

It is also known that advertisements (“ads”) can be selected and streamed to the viewer in conjunction with viewing a video on demand (“VOD”) program. Typically, the ads are selected for placement in advance of a movie (called a “pre-roll” ad), during a movie (called a “mid-roll” ad), or after the movie (called a “post-roll” ad). The ads can be selected once the VOD movie is determined and a playlist is formed. The playlist identifies the ads that are to be streamed with the program—in other embodiments, the playlist may also indicate the movie program as well. The ads can be selected based on various aspects, including viewer demographics and the particular movie selected. However, the selection of ads is typically not based on which products the viewer has purchased from different merchants, as the cable system provider typically does not know the viewer's purchasing history with regard to other merchants, let alone what merchants the viewer has patronized. It is also possible to provide ads with PPV programs, which also can be selected based on the viewer's demographics. However, as with VOD, the service provider providing the PPV program typically does not have access to the viewer's consumer purchasing habits. If the cable service provider did have access to this information, then the cable service provider could tailor the selection of ads for the viewer, resulting in more effective advertising.

Consequently, what is needed is a flexible system for selecting ads provided to a viewer of PPV or VOD programs, where the selection of ads is based on information regarding the viewer's consumer purchasing characteristics.

### BRIEF SUMMARY OF THE INVENTION

In one embodiment of the invention, a coupon system receives data used in generating a coupon. The coupon code is provided by a merchant to its customer, where the customer also is a subscriber and viewer of programming by a cable services provider. The user can then enter the coupon code as a viewer of the video service provider in order to receive a discount for viewing a program (such as a PPV movie) or to receive viewing authorization for a program that could otherwise not be viewed by the viewer. The video service provider uses information associated with the coupon code to then select an advertisement to stream to the user in conjunction with streaming the redeemed program. In another embodiment, a method is defined for receiving the coupon code from a viewer in a cable system, wherein a coupon system validates the coupon code and determines the user is authorized to receive a discount for viewing a program or otherwise receive viewing privileges for a program that would otherwise not be provided to the user and selecting an ad based on the coupon code. The ad and the program are then streamed to the viewer.

Various other embodiments of the invention are possible, and the above embodiments are not intended to limit the scope of the invention beyond what is claimed herein.

### BRIEF DESCRIPTION OF THE SEVERAL VIEWS OF THE DRAWING(S)

Having thus described the invention in general terms, reference will now be made to the accompanying drawings, which are not necessarily drawn to scale.

FIG. 1 illustrates one embodiment of entities involved with coupon generation.

FIG. 2 illustrates one embodiment of coupon distribution.

FIG. 3 illustrates one embodiment of coupon redemption.

FIG. 4 illustrates one embodiment of screen images associated with coupon redemption.

FIG. 5a illustrates one embodiment of the architecture for a coupon system.

FIG. 5b illustrates one embodiment of an Ad Selection system architecture.

FIG. 6 illustrates one embodiment of a process flow for coupon generation.

FIG. 7a illustrates one embodiment for coupon redemption along with selecting an ad based on a coupon.

FIG. 7b illustrates one embodiment of a process flow for coupon redemption and validation.

FIG. 7c illustrates one embodiment of a process flow in the Ad Selection system for selecting an ad.

FIG. 8 illustrates one application of the coupon system.

FIG. 9 illustrates one embodiment of coupon data structure.

FIG. 10 illustrates one embodiment of the process of associating CPRI data with a coupon file.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although some specific terms are employed herein, they are used in a generic and descriptive sense only and not for purposes of limitation.

Although certain methods, apparatus, systems, and articles of manufacture have been described herein, the scope of coverage of this patent is not limited thereto. To the contrary, various embodiments encompass various apparatus, systems, and articles of manufacture fairly falling within the scope of the appended claims either literally or under the doctrine of equivalents.

As should be appreciated, the embodiments may be implemented in various ways, including as methods, apparatus, systems, or computer program products. Accordingly, the embodiments may take the form of an entirely hardware embodiment or an embodiment in which computing hardware, such as a processor or other special purpose devices, is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods performed using computer hardware, apparatus, systems, and computer-readable program products. It should be understood that the blocks of the block diagrams and flowchart illustrations, respectively, may be implemented in part by computer-readable program instructions, e.g., as logical steps or operations executing on a processor in a computing system or other computing hardware components. These computer-readable program instructions are loaded onto a computer, such as a special purpose computer or other programmable data processing apparatus, to produce a specifically-configured machine, such that the instructions which execute on the computer or other programmable data processing apparatus implement the functions specified in the flowchart block or blocks.

### Service Aspects

Providing discounts to viewers in a video service provider can also be described as providing electronic coupons to viewers for redemption. As used herein, an electronic coupon is information which can be used to provide a discount for a charge associated with viewing a program, or authorization to view a program that otherwise would be unavailable to a viewer. The coupon is “electronic” in that information is provided at one or more stages of the process involves redeeming the coupon via electronic communication techniques. In contrast, traditional coupons, such as paper based coupons, are conveyed as printed materials. Typically, the coupon must be physically presented by the consumer at the time of purchase. However, the embodiments of electronic coupons disclosed may be electronically distributed and redeemed, but the embodiments do not preclude certain information from being conveyed as printed media during part of the distribution process. In the embodiments disclosed herein, the coupon indicates information that is provided to the viewer and used for receiving a discount (or viewing privilege) in conjunction with a video service (e.g., receiving a cable service), and does not pertain to purchasing a physical product.

In one embodiment, the coupon can be subsidized by a merchant from which the viewer has purchased goods. This could be, for example, a way the merchant can reward frequent shoppers, e.g., by providing the customer with a coupon for discounts on programs viewed on a cable services provider. In one embodiment, customer's purchasing information is associated with the coupon, so that identification of the coupon also allows identification of the viewer's purchasing characteristics. The video service provider can then use the coupon to select an advertisement associated with that merchant to be streamed to the viewer when redeeming the coupon.

The person using the coupon is variously referred to as a “subscriber,” “user,” a “viewer,” “customer,” or a “couponee” based on what aspect is pertinent at that time during the process. The person is a “subscriber” of a video service provider, such as a cable service provider and thus, is a “viewer” a video program (or simply “program”) billed at a reduced rate. The “viewer” can also be a subscriber that receives authorization to view a program that otherwise would not be provided to that subscriber. In addition, the person is a “customer” of a merchant that may provide the coupon and a “user” of the coupon system. Finally, that person is a “couponee” because they receive and redeem a coupon. The use of such terms does not limit application of the invention to only video applications, cable service providers, or to users having pre-existing billing arrangements with service providers. Rather, the use of these terms is to facilitate explanation of the invention by emphasizing a role of the person involved at various points during the process.

The “program” viewed is illustrated herein as a video based movie, sometimes embodied or referred to as a video asset. The content of the program may be of other types, such as a sports program, documentary, etc. Further, although the principles of the present invention are disclosed in terms of viewing a program, the principles can apply to listening to an audio program, playing a video game, etc. Further, although the principles of the present invention are disclosed in terms of a cable service provider, the principles can apply to various other types of video service providers, using other technologies, such as satellite distribution of video signals, fixed wireless transmission, mobile wireless transmission, and Internet based technologies. The “program” viewed is a video program which is typically available to subscribers of the video service provider on a pay-per-view (“PPV”) basis, potentially on a video on-demand basis, or is otherwise provided to subscribers of the video service provider (but not to the present viewer) on a subscription fee basis. Thus, the program may be available for viewing without redeeming the coupon, but may require a usage-specific fee (e.g., as in PPV) or subscription fee (e.g., subscribing to a particular service level). It is presumed that the viewer is electing to redeem the coupon so as to avoid paying the full usage specific fee (e.g., receiving a discount or no charge), or to avoid paying the fee for the required service level that would grant access to the program (otherwise, the subscriber would be entitled to view the program without a coupon).

Typically, the coupon is limited in some manner regarding its redemption, as it can be typically used (but not necessarily) only once by a cable subscriber to view a program, or used only once to receive a discount when viewing a program. In other embodiments, the coupon can be a “pass” for viewing a limited number of movies, viewing a movie a limited number of times, or based on some other criteria. In other embodiments, the coupon could be used to provide viewing privileges to a movie otherwise not available on a PPV or VOD basis to cable subscribers. For example, the coupon could be used to authorize viewing of a program, such as a preview of a newly released movie, which is not generally available to other subscribers of the cable system at all, but can only be viewed by a couponee redeeming a coupon.

When the viewer redeems the coupon for viewing a program, the video services provider may access information about the viewer based on the coupon code entered by the viewer. This information typically includes data about the viewer's purchasing habits or other consumer characteristics of the viewer. The video service provider then selects an ad based in part, on information associated with the viewer's purchasing habits, or a merchant indicated as being patronized by the viewer.

The service related aspects can be divided into three distinct phases. These are: a) the coupon generation phase, b) the coupon distribution phase, and c) the coupon redemption phase. Within each phase, there are various embodiments, so that one of the embodiments in the coupon generation phase can be combined with one of the embodiments associated with the coupon distribution phase, and further combined with one of the embodiments of the coupon redemption phase. During the coupon generation phase, information associated with the couponee's purchasing habits may be consolidated and identified via various descriptions of data. This information can be referred to herein as “Couponee Purchasing Related Information” (“CPRI”). During the coupon distribution phase, the CPRI may be distributed along with the coupon, but in some embodiments only a subset of CPRI data may be distributed among all the systems disclosed herein. Finally, during the coupon redemption phase, the CPRI data may be accessed for purposes of determining which advertisement should be streamed to the viewer in conjunction with the selected program. Thus, it is apparent that there are various combinations of how the coupon can be used and how an ad can be generated, and one skilled in the art will be able to appreciate that there are many combinations and embodiments possible in regard to how advertisement is selected for the viewer.

### Service Aspect: Coupon Generation Phase

The coupon generation phase refers to aspects associated with gathering and synthesizing various data inputs for formulating a coupon. In one embodiment, the coupon comprises information which can be used by a viewer to receive a discount to a pay-per-view program, or otherwise gain access to viewing a program that is not readily viewable by the viewer. The coupon can comprise CPRI information, which can be generated by merchants, maintained in association with the coupon, and used by video service providers, including for purposes of selecting which ad(s) is to be presented to the viewer. Thus, a viewer may be subscriber of a video service provider, typically, a cable service provider, with access to various PPV programs. The coupon may entitle the viewer to a discount based on a percentage or a flat fee (e.g., 50% off or $5 off) of the regular charge incurred when requesting a PPV. Or, the coupon may entitle the viewer to access a program associated with a service that normally is not accessible by the user. For example, the user may not be a subscriber to a premium programming channel (e.g., HBO®), but the coupon provides limited access for the subscriber to access the programming channel. The redemption of a coupon may inform the video service provider about which advertising to select for that viewer. Such marketing mechanisms allow the viewer to sample the premium programming channel as an enticement for subscribing to the service on a regular basis from the video service provider. Further, such marketing mechanisms may encourage the viewer to patronize certain other merchants in order to obtain additional coupons. Allowing the video service provider to tailor the advertisement to a particular viewer using an ad featuring the merchant also builds a relationship between the video service provider and the merchant. More specifically, this encourages the merchant to advertise with the video service provider, as the merchant knows its ads will be targeted to the viewer who is a frequent shopper of the merchant.

The coupon can be generated so as to be targeted to a particular subscriber, to a particular class of subscribers, or not targeted at all. For purposes of reference herein, the former two categories are “subscriber-targeted” or “targeted” coupons and the last category is referred to as a “generic” coupon. In the case of targeted coupons, the ad selected with the program can also be targeted to the particular subscriber or to a class of subscribers based on the CPRI data associated with the coupon. The coupon can be redeemed for a specific content or type of movie (which is referred to as a coupon targeted to particular content) or any type of program (which is referred to as a coupon for generic content). In addition, the selection of the ad may be determined not only on the CPRI data, but in conjunction with the particular movie selected. Thus, in one embodiment a coupon can be targeted for a particular individual and redeemable for a particular movie, or the coupon could be targeted for any subscriber and redeemable for any PPV movie, as can the ad selected by the video service provider, which is streamed with the movie.

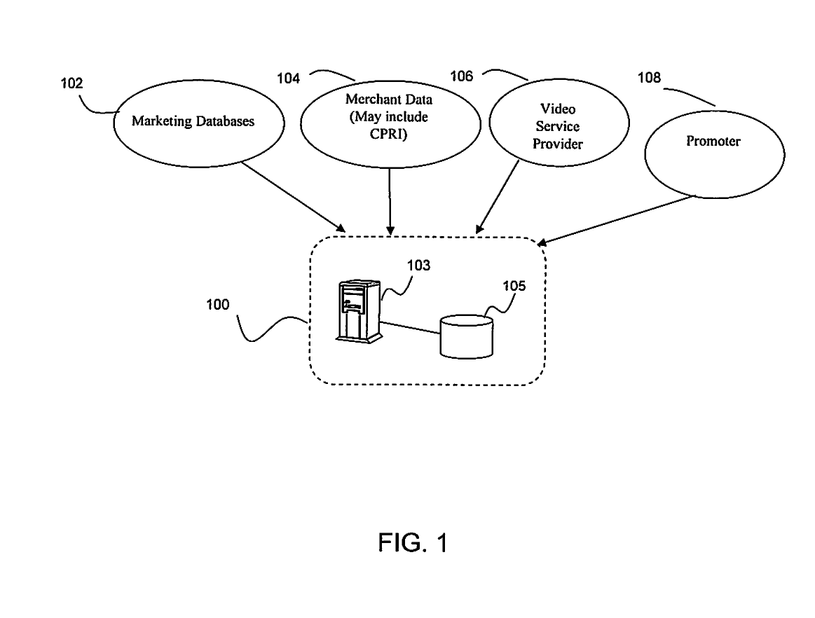

Based on the type of coupon used as defined above, the Coupon System (which processes the data associated with the coupon in various phases) receives and analyzes various types of inputs to create or generate a coupon. This is illustrated in FIG. 1 which discloses the Coupon System 100 (more of the particular architecture of the Coupon System will be discussed later). One potential input to the Coupon System includes data obtained from a third-party marketing database 102. These third party databases provide various information regarding particular individuals or demographics of individuals living in particular areas (such as postal zip codes) and are well known and available from various sources. In one embodiment, the data associated with this database is data characterizing groups of individuals, as opposed to particular individuals. In another embodiment, this can include individual specific information. This information can be used to identify particular types of viewers in a given area or identify characteristics of particular viewers in a given area. For example, lists of individuals who are cable subscribers with a certain income level, interest, religious affiliation, family status, etc., can be obtained for a viewing area. Thus, if the coupon is intended to target video programs for pre-school children, these third party marketing databases can provide lists of families with pre-school children in the appropriate cable service area. These “lists” may comprise names, addresses, email addresses, etc of specific individuals. This information may be used in the subsequent phase, which is coupon distribution.

Another input to the Coupon System 100 is information from specific third party merchants (“Merchant”) 104 selling a service or product whose customers are also subscribers of the cable service provider. The Merchant typically retains information regarding its customers, which may include the customer's buying habits, which potentially allows the Merchant to derive characteristics or categorize its customers. This information can be used to generate the CPRI, which is then associated with the coupon. In various embodiments, the Merchant can synthesize CPRI data, or provide data to the Coupon System allowing it to develop CPRI data. For example, many grocery store chains offer discounts to purchasers using a “shopper's discount card.” These cards allow the grocery store to track and classify the purchasing habits of its customers. Thus, a grocery store chain can observe when an individual begins to regularly purchase a certain type of product (e.g., baby diapers), and thus is able to ascertain that the individual's family status. Further, it is well known that other merchants track their customer's purchasing habits. For example, airlines track the tickets purchased by their customers. Hence, an airline can derive potential interests of their customers based on the locations that they fly to. Such information from a Merchant could be useful in targeting a coupon for a program to a particular viewer. For example, viewers that travel frequently may be offered a coupon for viewing a travel channel program (which the viewer normally does not view because they do not subscribe to that channel). Further, it would be desirable to also select an ad featuring the airlines when the user is viewing the program. Thus, the CPRI can include information about what products or type of products the customer has purchased, spending levels, how frequently the customer purchases from the Merchant, and whether the customer has reached a certain status based on the merchant's classification (e.g., a “gold level shopper”). The Coupon System uses these inputs in one embodiment to ascertain individuals with certain criteria, including those individuals that patronize the Merchant and Video (e.g., Cable) Service Provider. The Coupon System can determine that the individual has a known interest which can be aligned with the viewing opportunities offered by the Cable Service Provider. Further, an Ad Selection system can then use this same information to then select and target an ad based on the viewer's purchasing habits, based on the Merchant patronized or the products purchased.

Another source of data to the Coupon System 100 is information from the video service provider 106. Typically, the video service provider is a cable service provider (“CSP”), but this should not be construed as limiting the video service provider to a certain type of technology. The CSP can be aware via various mechanisms of the viewing habits of the viewer, and is aware of the viewer's subscription status. For example, a CSP typically offers various levels of service at differing subscription levels (and different prices) to its viewers. Consequently, the CSP knows whether the viewer is subscribing to a basic level of service or to a premium level of service. A basic level of service may prohibit the user from viewing the content on certain channels, and hence in one embodiment it would be appropriate to offer such viewers a coupon for viewing these channels. Obviously, if a subscriber has access to the full complement of programs offered by the CSP, then it would not make sense to offer a coupon for allowing access to the subscriber channels or programs that are already available to the subscriber. However, even a premium level subscriber could be offered a coupon for a PPV program which provides a discount for a PPV program or for accessing a program that otherwise is not allowed, or allows access to a particular program only to those subscribers using the coupon. This would allow the CSP to increase usage of PPV programs and/or further develop its relationship with premium level subscribers.

Another source of data to the Coupon System 100 is information from a promoter 108. The promoter typically is associated with a particular form or type of content. For example, the promoter may be promoting an upcoming movie, which is to be available for PPV by the CSP. Other examples include the promoter advertising a one time sporting event (e.g., an international soccer championship). Other promoters may be distributors of content, such as a producer of a subject matter of programming (e.g., cooking or travel related content) that is attempting to generally increase viewership to its programs. One such example of a promoter could be a content distributor or content provider, such as HBO®. Thus, targeting a coupon for particular content or video program may be compatible with the goals of the promoter.

As evident, each of the input sources provides information that can be used to target a coupon to a particular subscriber or class, or target the content of the coupon. Thus, these types of information may be used when providing a subscriber-targeted or program-targeted coupon. Further, this information can be used indirectly or directly by the video service provider in selecting the ad to be viewed with the program. Other forms of input are possible that can be used to identify a subscriber or class of subscribers, or used to identify particular content that a coupon can target. It evident that not all possible information sources are required to generate a coupon or provide information associated with a coupon. In one embodiment, a coupon is directed to generic subscribers in a viewing area and thus there is no need to ascertain particular subscriber aspects. Hence, a third party merchant may not be involved. Alternatively, if a coupon is generic with respect to programming content (i.e., the coupon could be used for redemption of a variety of type of programs), it may not be necessary to have input from a promoter targeting a particular program. However, if coupons are targeted to particular types of subscriber's (e.g., families with pre-teenage children) and the coupons are targeted for a particular type of program (an upcoming movie where the plot involves pre-teenage children), then the Coupon System may use such inputs in generating coupons. Further, the selection of ads to be played for that targeted type of subscriber may also use CPRI associated with that coupon.

In one embodiment, the Coupon System 100 receives data from the various sources 102, 104, 106, and 108. Marketing databases typically offer their information at a price, so that it is possible for the Coupon System to access such data only as needed or desired. A promoter 108 may be involved and it typically pays or otherwise subsidizes a program as part of promoting that particular movie, so again, promoter-related information may be available as an input to the Coupon System. However, Merchants 104 and video service providers 106 may guard their customer information and may not readily disclose it to the Coupon System (especially, depending on the which third party entity may own or operate it). In such cases, the Coupon System may controlled and/or operated by the Merchant or the Video Service Provider. Thus, if a Cable Service Provider (“CSP”) operates or controls the Coupon System, the CSP may be willing to provide subscriber viewing information to the Coupon System.

In other embodiments, the coupon generation process may be distributed, with certain aspects occurring in the Coupon System, and other aspects occurring in a Merchant's system. Thus, in other embodiments, a hybrid arrangement may occur where a portion of the coupon generating is done in a distributed basis. For example, the Coupon System may be operated by a CSP, and the Coupon System generates a series of coupons for a particular program (based on input from a promoter) for certain subscribers of a certain income level (using input from a marketing database) and for subscribers which do not regularly elect to view a PPV program (using input from the CSP). The Coupon System may generate a fixed number of coupons (more specifically, “coupon codes”), and electronically provide them to the Merchant along with information indicating how the coupons were determined. The Merchant may then elect to provide these coupons to certain frequent customers. The Merchant may further elect to compile or generate the CPRI based on internal shopping information prior to distribution of the coupon codes to the Merchant's customers and further link that information with a coupon file. For example, the Merchant could be a pizza chain and is advertising a promotion that provides a coupon for a free movie when a pizza is purchased and delivered. Alternatively, the Merchant could be a grocery store that provides a coupon to certain shoppers spending over $100 on groceries. Further variations are possible. In the latter example, the Merchant could compile a computer file based on previously received coupon codes where the coupon includes an indicator explicitly identifying the coupon as being associated with a shopper who has spent over $100 on groceries.

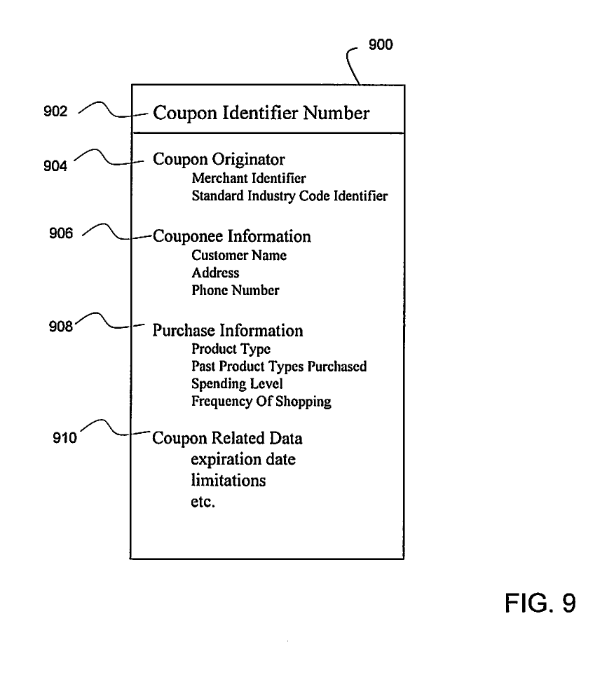

The coupons generated and/or stored by the Coupon System typically comprises a computer file comprising coupon codes. In some embodiments, the coupon codes comprise records with further information identified, including CPRI information which are determined by the Merchant. One embodiment of a coupon record is shown in FIG. 9, where the coupon 900 is illustrated as a data structure comprising a coupon identifier number (or “coupon code”) 902. The coupon identifier is a number, typically unique within the Coupon System, that identifies the coupon. In many embodiments, the Coupon System determines this value so as to avoid potential duplication of the coupon code value. The coupon identifier number can be used as an index to related coupon information stored in another file (if the CPRI is not stored within the coupon). Storing the coupon code separate from the other coupon information allows the coupon code to be conveyed from a third party Coupon System to a cable service provider without necessarily disclosing the other coupon information. Other embodiments may structure the coupon file/coupon code in various arrangements. In the embodiment shown in FIG. 9, the coupon comprises related coupon information, some of which can be considered as CPRI, and other types of information.

Some of the information in the coupon can include sub-fields, such as an identifier of the Coupon Originator 904, which comprises a merchant identifier, which can be numeric or text. Further, this can be structured in various forms, such as using HTML. Further information may be included which classifies the type of industry the Merchant is associated with. This can be accomplished by using a standard industry code (“SIC”) identifier or other type of identifier. This information allows identification of the type of goods or services offered by the Merchant.

Other information in the coupon may include the “Couponee Information,” which is information about the targeted individual to receive (or which did receive) the coupon. In this embodiment, the coupon is targeted to a specific individual, and subsequent fields indicate the couponee's address, phone number, or other information associated with identifying the individual. In other embodiments, a “classification” indicator may be used indicating whether the coupon pertains to a 1) specific couponee as identified, 2) a class of couponees characterized as defined, or 3) generic, e.g., the coupon is not classified based on any type of couponee characteristics. In some embodiments, the Merchant will determine the Couponee Information. The Merchant can still provide a Merchant identifier even if the couponee is not identified.

The coupon may also comprise Purchase Information 908, which in this embodiment, is an example of CPRI data. The data that is associated with this field can indicate the specific or particular product or products purchased from that Merchant, the types of products purchased (e.g., electronics, food, office supplies, etc.), the spending level, and the frequency of shopping. The may be indicated in absolute values (e.g., couponee spent over $500/year) or based on a label defined by the Merchant (e.g., couponee is a “silver” level customer). Again, this information is typically provided by the Merchant based on the viewer's purchasing habits with that Merchant.

The coupon may include other information, such as Coupon Related Data 910, which can include an expiration date, other limitations associated with the coupon, such as number of uses, restrictions on the movies that it can be used to redeem, etc.

The above information may be optional in various embodiments. For example, coupons may originate from a Merchant, or they could originate from a Promoter, or other entity. Typically, the Coupon Identifier Number is unique, so that it is easier if the Coupon System determines this value to avoid duplicate values. In one embodiment, the Coupon System determines the Coupon Identification Number and other information, while the Merchant may populate other fields. Thus, the Coupon can be generated by using data from multiple entities. The coupon structure of FIG. 9 is one embodiment of a data structure for a coupon, and not all coupons will include all the data, nor in the same structure, nor have been created in the same way.

The coupon codes are redeemed and typically entered by a viewer to receive access to a program or to receive a discount for viewing a program. Thus, generating the coupons typically involves generating a computer file comprising coupon codes. The coupons codes are typically unique, and typically have a limited time of use (“lifetime”) before they expire, and typically can be used once (“limited use”). However, in other embodiments, they can be used more than once by a viewer, only once by multiple viewers (this information can be indicated in the coupon), or used in other ways. Consequently, providing coupons to the Merchant in the above example comprises transferring a file with the various coupon codes, with certain fields populated. These codes can be indexed and numbered, and can further be associated in bulk or individually with data that was used to generate the coupon. Thus, coupon codes can be associated for a particular program or subscriber type either by information contained in the coupon file (for each record) or in a separate file. It is also possible to even associate a coupon code for a particular subscriber (which is the case when certain forms of distribution are being used). For example, the Coupon System could indicate to a Merchant that 10,000 coupon codes, numbered 58,000-68,000 are allocated to the Merchant for a movie promotion that the Merchant can then distribute to its customers. The Coupon System could generate a file with these coupon code identifiers, with the Merchants Identifier 904 pre-populated. In other embodiments, the Merchant could provide further information that is used to populate Couponee Information 906 or other fields.

It is necessary for the CSP involved in redemption to plan for redemption of a coupon (e.g., the CPS must be willing to validate a coupon). The CSP is typically involved at the same time that the coupons are generated, and usually prior to distribution of the coupons. Thus, the CSP may also be provided with the coupon code file, or a subset thereof, so that redeemed codes can be compared as valid. In other embodiments, the CSP may be provided the coupon code, and can access in real time other information associated with the coupon (e.g., the CPRI). The CSP may query a Coupon System such that the CSP can then select a particular ad associated with a particular Merchant for that coupon. Typically, at least the Coupon System retains a copy of all coupons distributed. In certain embodiments, the Coupon System may serve a plurality of video service providers and a plurality of Merchants, and hence only the Coupon System maintains a copy of all coupons.

### Service Aspect: Coupon Distribution Phase

The coupon distribution phase refers to the transfer of the coupon to the subscriber as well as the distribution of the coupon code file to the appropriate CSPs, or other entities involves with processing the coupon file.

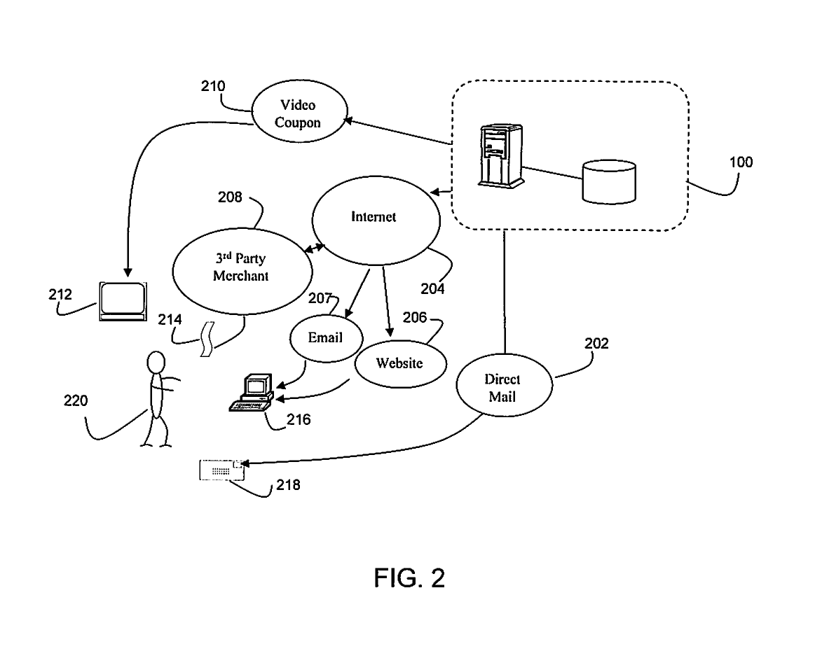

The coupons are often distributed in electronic form, but can be transmitted in a physical manner, typically involving the step of providing them in some form to the couponee. Some of the various methods of distributing coupons are illustrated in FIG. 2. The coupons originate from the Coupon System 100 of FIG. 2 as a result of the previously discussed coupon generation phase. The Coupon System 100 can provide the data to a direct mail marketing entity (not shown) that prints out the coupon codes on paper, along with any other desired promotional material, and mails the coupon as a direct mailing 202 resulting in an envelope 218 being delivered to the viewer 220 via postal mail or other suitable delivery service. The Coupon System may provide the associated viewer's name and address, or may provide the coupon code in a file with the names and addresses separately determined (either by the Coupon System or the direct mail marketer) to a third party that actually distributes the coupons. Other forms of direct mail distribution are possible, including providing an insert in a newspaper, magazine, or other tangible item delivered to the viewer 220. Typically, the coupon bears the coupon code, and instructions for redeeming the coupon. If the coupon is for specific content, then additional information is typically provided indicating the particular content that can be redeemed using the coupon.

Various electronic forms of distribution are depicted in FIG. 2. In one embodiment, the coupon is electronically transferred via email to an email or SMS address 207 associated with the user 220. Thus, a user can access the coupon using a computer 216, or other suitable device, including a cell phone, a cell phone with a mobile browser, netbook, etc. The coupon is typically sent as an attachment that can be printed out, or the coupon code can otherwise be noted by the user (e.g., the user could copy the coupon code onto a separate piece of paper). An alternative distribution form is to load the coupon codes in a website 206, where the user 220 can use a computer 216 to access the web site, as well as be allocated a coupon as appropriate. Well known computer systems comprising processors, memory, and disk storage can be used to construct the email servers 207 or web servers 206. In either embodiment, the coupon code is typically associated with a particular user, since the user individually receives the coupon code.

Other forms of coupon distribution are possible, and one such distribution method is illustrated as a “video coupon” 210, which provides the coupon to the user's television set 212. This form of distribution can provide a visual indication of the coupon code to the user in various circumstances. For example, in one embodiment, the cable headend sends the coupon code to the set top box (not shown) which is programmed to provide a “banner” displayed at the bottom of the television screen which scrolls a message to the user (e.g., “your coupon code for viewing a free premium channel is 12345”). Alternatively, when the user selects a function key on their remote, the user can invoke the PPV function and may be informed of the coupon code at that time. Typically, these codes have a limited duration, so that they must be used within a time period. Other forms of electronic distribution are possible, including instant messaging, short messaging service (SMS) used for wireless service, etc.

Another form of distribution involves a third party merchant (“Merchant”) 208. In this form, coupon file or portion thereof is distributed to the computer system operated by the Merchant. The Merchant may provide the coupon code to the purchaser on a printed receipt 214 at the time of purchase. Thus, a user purchasing groceries at a store may have a coupon code printed on the bottom of their receipt informing them they can redeem the coupon code at a CSP. It is well known that Merchants have “loyalty” reward systems in place for identifying a purchaser (such as those using a frequent shopping discount card) at checkout. Thus, the Merchant's systems can allocate a single coupon code value from a set previously provided to the Merchant, or query in real time the Coupon System for a coupon code to provide to the customer. Other variations are possible. Typically, these Merchant loyal rewards systems comprise a processor and database for storing shopper's purchasing history, related marketing data, and other shopper profile data. For example, the Merchant may have separate pre-printed coupons which are physically handed to the purchaser at the time of purchase, as opposed to printing it on the customer's receipt. Regardless of how the coupon is provided to the purchaser, the purchaser is informed of the coupon code by the Merchant. The purchaser is typically the viewer that is redeeming the coupon. Other forms of distribution are possible. For example, the coupon code can be integrated into a product, such as pre-printed on the inside of a label, lid, or on the wrapping of a product.

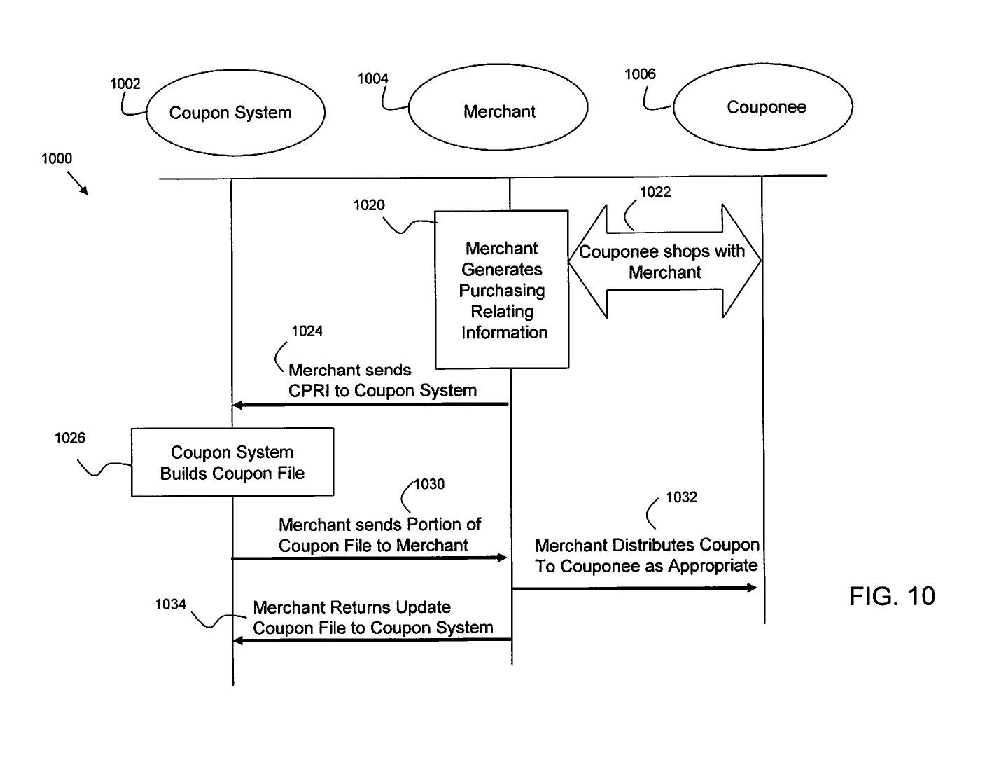

FIG. 10 illustrates one potential form of distribution 1000, which includes how CPRI information can be associated with the coupon file. In FIG. 10, three entities are represented, the Coupon System 1002, the Merchant 1004, and the Couponee 1006. This embodiment presumes that the Merchant will generate some sort of purchasing related information about its customer (the couponee) which is then associated with the coupon file. The Couponee shops from the Merchant in step 1022 which may occur over time, and may involve several purchases. The Merchant in step 1020 is generating information about the customer's habits. At some point, the Merchant may transmit all or a subset of this data in step 1024 to the Coupon System. The Coupon System then processes this data into the coupon file in step 1026. The Coupon System typically generates the actual coupon codes, because the coupon code values must be unique to the Coupon System, and hence are typically not generated by the Merchant. The structure of the Coupon as shown in FIG. 9 may be then generated, and in one embodiment, this data structure can be unique to each Merchant. The Coupon System then may transmit the coupon file, or a portion of it, which includes the coupon codes in step 1030. The Merchant may integrate the coupon code into its files. In another embodiment, the coupon file with the coupon codes are provided to the Merchant in a coupon file with certain data populated, and the Merchant then populates various other fields in the coupon file comprising CPRI data. In this embodiment, the Merchant then passes the coupon code to the couponee as appropriate. Typically, the Couponee receives only the coupon code and instructions. For example, in one embodiment the Couponee may receive that particular coupon code printed on their receipt when they shop at the Merchant. At this point, the Coupon System has in its coupon file that particular coupon code, and associated with that coupon code is information indicating a Merchant, along with information about the Couponee's purchasing habits. Consequently, when the Couponee redeems the coupon, the Coupon System knows based on the Merchant identified in the coupon file the appropriate advertisement to select. The Merchant may, in step 1034, provide an updated coupon file back to the Coupon System, in certain embodiments.

As described above, in one embodiment the Coupon System may correlate the coupon code with the user. In other embodiments, such as when the coupon code is obtained from the website, pre-printed on a product label, or on a card that is handed by the Merchant to an arbitrary purchaser, the Coupon System may not be able to track which individual receives the coupon code. Thus, in certain embodiments it is possible for the redemption of the coupon to be limited to certain subscribers (e.g., the coupon cannot be redeemed by another household). Even if the subscriber cannot be identified, it still may be possible to use information identifying a particular Merchant that distributed the coupon, but it may not be possible to identify which particular customers of the Merchant received the coupon. However, the video service provider may be still able to select an ad based on the Merchant without knowing the particular individual that is receiving the coupon.

In other embodiments, other information can be combined with the coupon code so that the coupon generation and coupon distribution is intermixed, or occurs in a distributed manner. For example, a Merchant may receive a list of coupon codes applicable for redemption for a particular movie, or a movie from a particular content provider (e.g., HBO®). (This is part of the distribution phase.) The Merchant can then combine information about particular shoppers when selecting the coupon, so that coupons are determined to be allocated for certain groups of shoppers. (This could be considered part of the generation phase). The Merchant could accomplish this in conjunction with obtaining information from another party. For example, the Merchant could receive a list of desired programs or past programs viewed by the subscriber from a cable service provider. Finally, once the Merchant has completed the processing of determining which coupons should be allocated to which shoppers, the Merchant can provide the coupon code to the shopper upon checkout. (This could be considered as part of the distribution phase again.) Thus, the phases are not required to occur as wholly distinct and complete processing steps.

In the above example, because the Coupon System provided a range of coupon codes to the Merchant, it is still possible to associate a coupon code with a particular Merchant, for purposes of selecting a particular ad to play during redemption of the coupon. If specific couponee information is associated with the coupon, then the CPRI may be further used to select the ad.

### Service Aspect: Coupon Redemption Phase

The coupon redemption phase refers to the procedures and systems used in redeeming the coupon by the viewer, in order to receive a discount, or to otherwise access a program that the subscriber would not be able to normally view. The viewer may be made aware of the program to be redeemed by consulting a program guide (on-line or otherwise) informing the viewer of the various programs available for viewing or this may be indicated on the coupon in some manner. In other embodiments, the user may be informed via a VOD or PPV service, presenting the user with a list of movies or programs that can be requested using the coupon. As noted, if the program is already available to subscribers of a certain subscriber service level, then the viewer is already authorized to view the program, and the coupon would be of little value to the subscriber. However, such a subscriber could benefit from receiving discounts to PPV events. As used herein “discount” means a reduction in price charged which includes not charging any price.

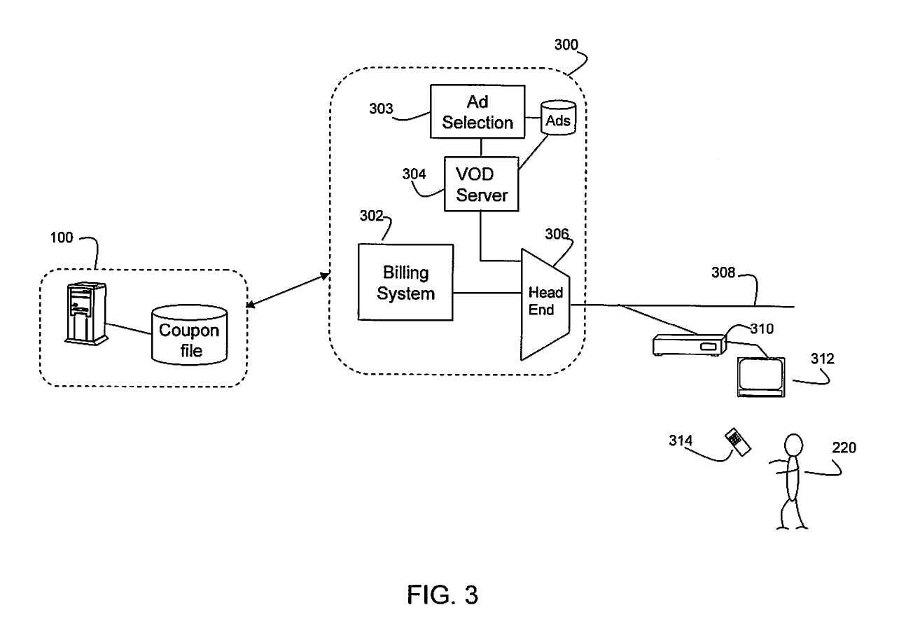

FIG. 3 illustrates one embodiment associated with redeeming the coupon and selecting the ad to be played. FIG. 3 illustrates the Coupon System 100 that communicates with the cable service provider 300, which comprising a billing system 302, a video-on-demand (VOD) server 304, a headend 306. Further, the CSP typically has a hybrid fiber coax (HFC) distribution network 308 to which a set top box (STB) 310 is connected to receive signals. The STB in turn is connected to the viewer's television set 312. The user typically uses a remote controller 314 as an input device. The cable distribution network 308 is presumed in this embodiment to have a two-way capability.

Although the present invention is illustrated using a set top box for convenience, but other embodiments may utilize different types of customer premised video processing equipment (“CPVPE”), such as a television with a CableCARD®; a DVR, adapter card for a PC, etc. The CPVPE can, in certain embodiments, receive video signals on a cable company coaxial cable interface as well as receive video signals delivered using different technologies (e.g., optical fiber interfaces, LAN type interfaces, or wireless interfaces) and which use various communication protocols or modulation schemes. Further, in various embodiments, the CPVPE can adapt the signals to be displayed on various devices, such as an analog television, digital television, PDA, computer monitor, etc.

The user 220 typically elects the desired program, and typically one of two possible circumstances exist: 1) the program is a PPV, and the coupon code is used to provide a discount or avoid the charge, or 2) the program is not a PPV program, but is a program that otherwise the user is not authorized to view (e.g., the program is available via subscription to a service level which the user has not subscribed). Regardless of the billing or service subscription arrangement, the VOD Server 304 refers to the components which store and then playback the video as requested, regardless of whether it is considered a VOD service or a PPV service. Typically, a VOD server is used to provide PPV services as well as VOD services.

Although the present invention is illustrated using a VOD server, other embodiments may utilize other types of equipment configured to stream video. Thus, any video delivery platform, whether referred to as a VOD server, video server, or other, could be used in various embodiments for streaming video programs to viewers using satellite communications, wireless (cellular) communications, or other distribution technologies.

In the first case, the existing PPV procedures can be invoked, which are then modified to allow the user to enter the coupon code, and the discount is then indicated. In the second case, the user elects the program, and instead of receiving a denial of service, the user is prompted to enter the coupon code. Upon successful validation of the code, the user may view the program. Validation as used herein refers to the various tests that may occur to ensure the coupon code allows the subscriber to redeem the coupon code.

The user typically enters the coupon code using the remote controller 314 in response to visual instructions provided on the television 312. These visual instructions can be generated by the STB 30, or by other devices in the CSP 300 as is well known in the arts. The user input is received by the VOD Server 304. In one embodiment, the coupon code is passed to the Coupon System 100 by the VOD Server 304 to determine if the code is valid. In other embodiments, the Coupon System can, in response, query other systems, such as a promoter's database to ensure the coupon code is valid. Upon validation, the Coupon System 100 informs the VOD server that the coupon code is valid. In addition, the Coupon System may pass along the CPRI associated with the coupon. Upon being informed that the coupon code is valid, the VOD Server can then select the ad, and stream both the ad and the program. In some cases, the VOD Server or other cable system component may send appropriate decryption information to the STB to allow viewing of the program.

After the selected program has been authorized, the cable service provider 300 can then determine which ads to stream with the program. The VOD Server 304 typically initiates a request to the Ad Selection system 303. In one embodiment the Ad Selection system 303 also receives the CPRI and movie identifier, and matches the advertistment(s) that match up with the CPRI and the movie identifier. For example, the CPRI may indicate that the Couponee frequency purchases baby diapers and baby food from a particular grocery store merchant, and that the movie identifier is for an animated movie. In one example, the Ad Selection system may retrieve an advertisement featuring the Merchant grocery store chain. The Ad Selection system may have a number of ads from the Merchant grocery store, and based on the CPRI purchasing history, the Ad Selection system may select an ad within the set of ads targeted to purchasing baby supplies. Thus, in one embodiment, the hierarchy is to use the Merchant Identifier to select a subset of ads (those associated with the Merchant) and then select from therein, a particular ad that matches up with the purchasing habits of the Couponee. However, other schemes maybe used as determined by one skilled in the art.

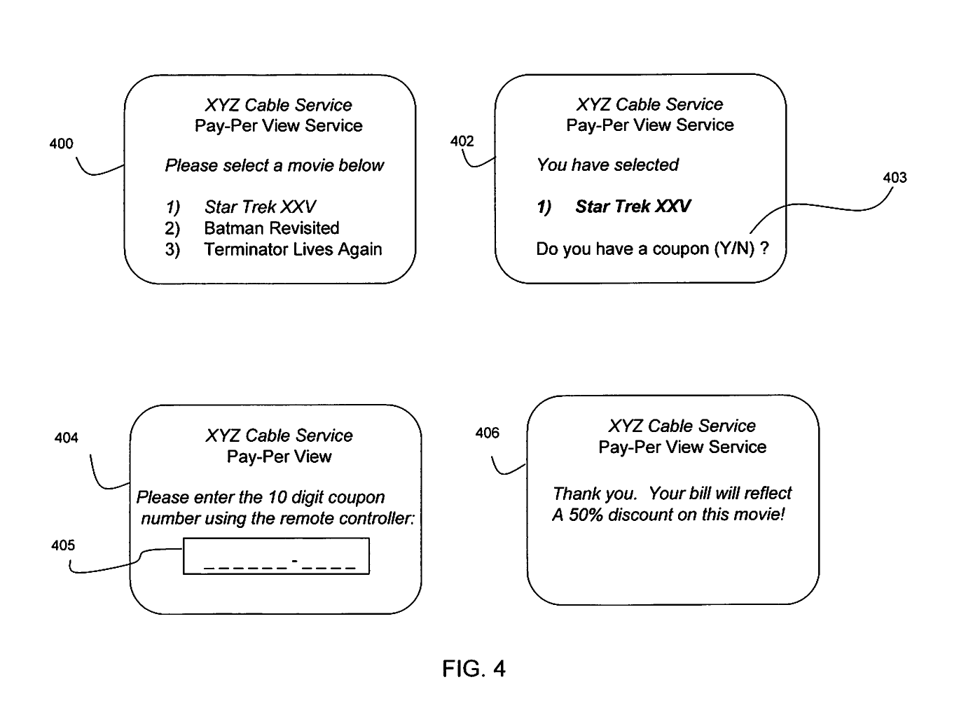

One embodiment of the graphical user interface (GUI) for a user interacting with the service is shown in FIG. 4. This can be accomplished by the CSP downloading an application to the STB modifying the menu processing for VOD programs. In this figure, screen 400 is an image which a user may be presented with for selecting a movie among a list of recently released movies. A typical menu structure is shown where the user selects a movie using a number, which is entered using a remote controller. After selecting a movie, the next screen image 402 is presented confirming the selection, and prompting 403 the user as to whether a coupon is being used. Assuming the user responded “yes,” then screen image 404 is presented to the user. There, the user is prompted to enter the coupon code, which in this embodiment is a 10 digit number separated by a dash. The user enters this value in the text box 405 using the numerical keys of the remote controller. Upon completing the coupon code entry, the next screen presented is screen 406, which confirms a discount provided to the viewer. In other embodiments, the user may receive the program at no charge, which would result in the user being informed via the GUI that there no charge is levied.

### Coupon System Architecture

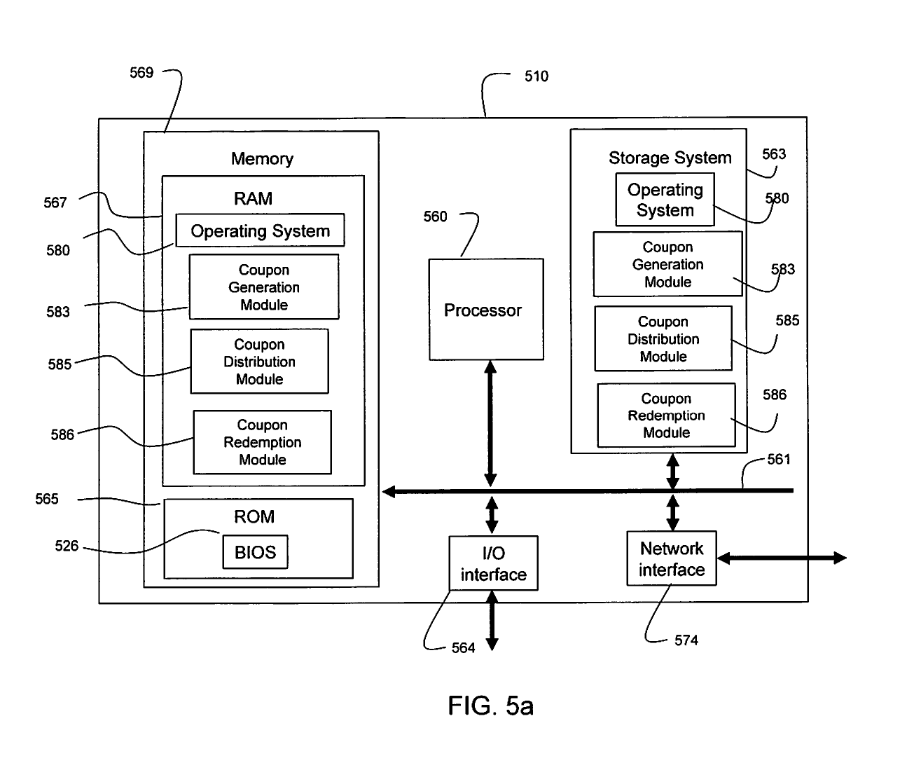

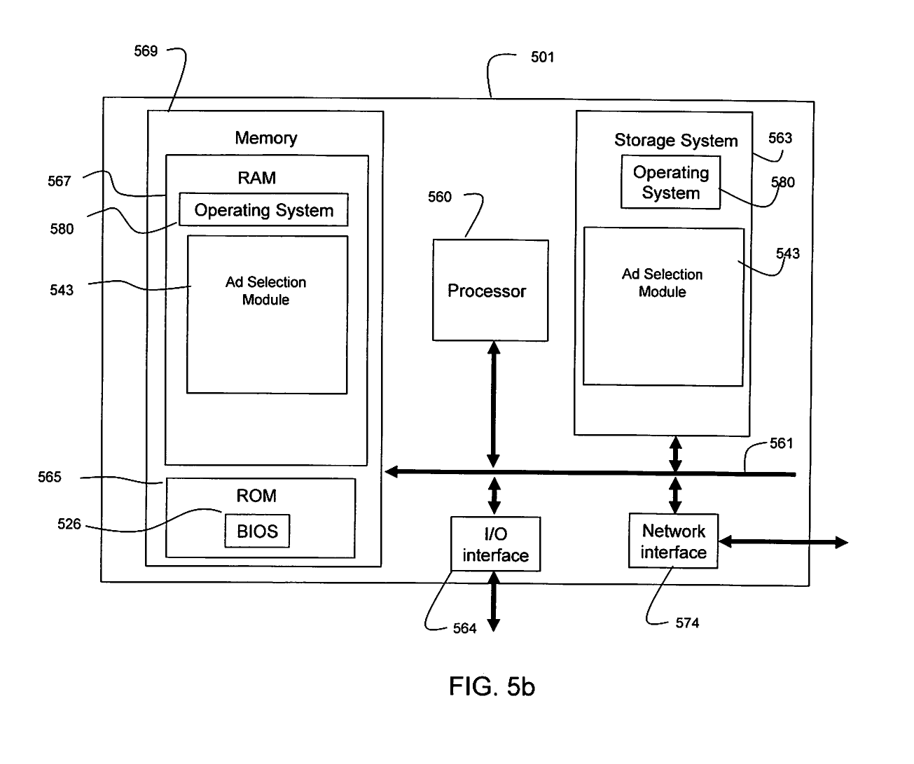

The Coupon System 100 of FIG. 1 comprises a processor 103 and a data store 105. In various embodiments, the data store can be a disk-storage system or a database. The system architecture is shown in FIG. 5 in further detail. In one embodiment, the Coupon System 510 is shown as comprising a processor 560, which can be a single microprocessor as shown, or in other embodiments, multiple processors functioning as a logical entity. The processor 560 typically communicates with primary memory 569 that comprises RAM type memory 567 and ROM type memory 565. The RAM memory stores a copy of the operating system 580 to control the overall system, and the RAM further stores three program modules. The coupon generation module 583 is the module that receives various inputs and generates the coupons, which can be subscriber targeted or generic, and/or content targeted/generic. The coupon distribution module 585 then distributes the coupons previously generated using any of the aforementioned mechanisms. Finally, the coupon redemption module 586 may validate the coupon code as requested by a cable service provider communicating with the Coupon System 510. The basic input-output system (BIOS) module 526 is programming code that initially controls the system upon power up.

The storage system 563 may be a separate disk storage system, or may be integrated, and also stores a copy of the operating system 580, the coupon generation module 583, the coupon distribution module 585, and the coupon redemption module 586. These are stored so that they can be loaded into main memory 576 upon power up.

The memory and processor communicate over a bus 561, and can also send and receive data from an input/output interface 564 or a network interface 574, the latter which is often connected to the Internet (not shown). The coupon file may be stored in memory or in another disk system.

A variety of computer systems architectures can be used for the Coupon System, including distributed processors, servers, various types of operating systems, programming languages, etc, that are well known in the art.

FIG. 5b discloses the architecture for the Ad Selection system 510, which is similar in structure with the Coupon System, and hence there is no need to replicate the description of the corresponding similar components. However, the Ad Selection system stores and executes software shown as the Ad Selection Module 543, which receives the CPRI and identifies the appropriate advertisement based on the merchant identified, and perhaps other CPRI data.

### Coupon Generation Processing

The coupon generation module is the program that generates the coupon file. The coupon file is a series of records, each which may be called a coupon record, and where each coupon record has one coupon code. Each coupon code may in turn have CPRI or other information. Typically, the coupon records are indexed by their respective coupon code values, but not necessarily. The process of generating the coupon file (and the content and structure of the coupon file and coupon records) is dependent on the type of coupons generated. It is possible for the Coupon System to have two or more files making up the coupon file: one file comprising the coupon codes, and a series of other files which are indexed by the coupon code. In this manner, it is possible for the first half of the coupon codes to point to a set of records comprising CPRI for a first merchant, and a second half of the coupon codes pointing to another set of records comprising CPRI for a second merchant. The two merchants may have different CPRI file structures, and hence, each can define, receive, and process their respective CPRI files. The Coupon System may allocate different syntax or value ranges in the coupon number identifier to identify this distinction.

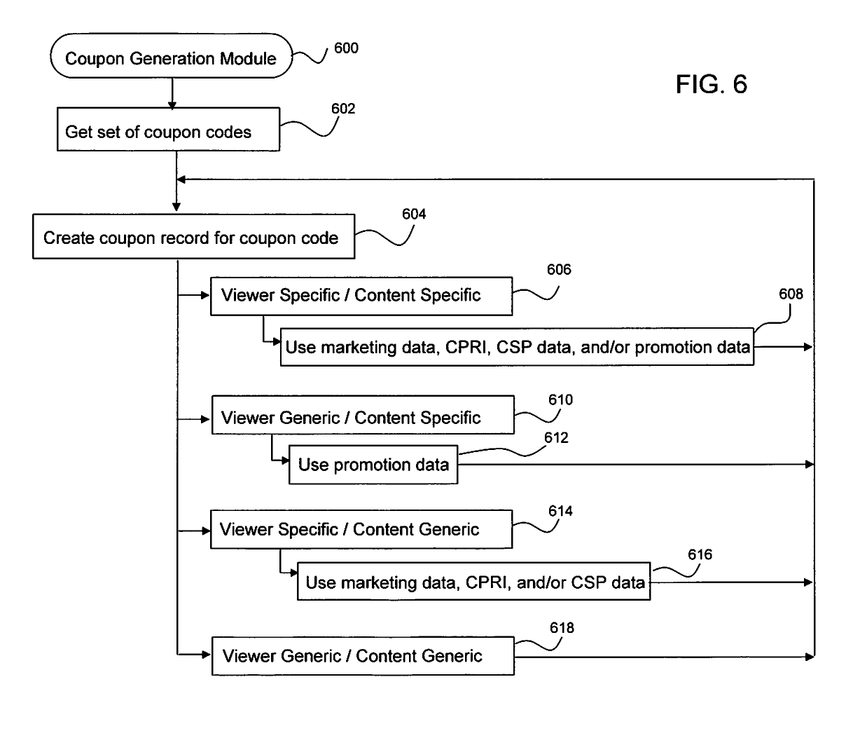

At a high level, generating the coupon file involves associating or allocating a set of coupon codes to the records, along with other information as appropriate. One embodiment of this process is shown in FIG. 6, which illustrates the type of coupon records which can be created, which influences the analysis of the inputs available to the Coupon System for generating the coupon file.

The process 600 begins with obtaining a set of coupon codes 602 which are to be used in creating the records. Typically, this is a sequential range of unique values. Typically, each distinct coupon code corresponds to one record and the process loops to create the coupon record in step 604. There are four types of records shown in FIG. 6 that can be created, and the records in a coupon file can be homogenous, or the record structure can differ. The coupon code values can be allocated contiguously and associated with a particular Merchant. For example, codes in the range of 1,000,000,000-1,001,000,000 could be coupons codes associated with a regional grocery store chain. Thus, the system can then pre-populate certain information, such as the Merchant Identifier.

The first type of coupon record is viewer specific/content specific 606. This type of coupon record is created for a specific viewer (subscriber), or type of viewer. Essentially, the viewer has been targeted based on some criteria. The viewer can be targeted individually or as having a specific attribute. Further, the coupon is applicable for specific content. Thus, there is some association of the content for which the coupon can be used. For example, coupon records can be created for viewers of a particular CSP that have an income greater than a defined threshold and the coupon can be for targeted for redeeming a particular PPV sporting event program. Consequently, the CPRI data may be used when defining the coupon record, and stored in the coupon record. Thus, to create this type of record, the Coupon System requires some sort of input data, which can be marketing data, CPRI data, and/or data from a CSP that is used to identify a subscriber or type of subscriber 608. In addition, because particular content is targeted, promotion data is also required. Typically, the determination of which program to promote is determined by a promoter or the CSP, which can be of various types of programs. Thus, a program producer may provide incentives for viewers to see programs that the producer distributes, or the CSP may provide incentives for its viewers to “upgrade” their service level. Or, a Merchant may desire to have coupons distributed to a select set of customers having a particular purchasing characteristic (e.g., their high valued customers). The exact process of forming the coupons and the structure of the coupon file can vary, and those skilled in the art can readily define different embodiments of viewer targeted/content targeted coupons.

Another type of coupon record that can be created is shown in step 610 which is viewer generic/content specific. Because this coupon is viewer generic, it is not targeted to a specific viewer or type of viewer. Thus, the Coupon System typically only needs to use promotion data 612 in forming the record, and there is no need for analyzing data pertaining to individual subscribers or attributes of types of subscribers. In this embodiment, the coupon is directed to any viewer, but the coupon's purpose is to promote viewing of a particular program. In generating a coupon that is generic to viewers, in certain embodiments, the coupon is used to provide a discount to a PPV event. Because the coupon is generic to all viewers, some of those viewers are likely subscribers at a premium level—that is, they can readily access all programs that can be accessed via subscription. It would provide little benefit to provide these viewers a coupon authorizing access to channels they can already access (because they can access all channels). On the other hand, even premium level viewers would benefit from a discount from a PPV event. Nevertheless, there can be benefits to distributing such coupons allowing access to premium channels, as it would benefit those subscribers which do not already have access to such premium channels.

The third type of coupon record that can be created is a viewer specific/content generic shown in step 614. This type of coupon is targeted to a specific viewer, or type of viewer, but is not specific to discounting or providing access to any particular program. For example, a CSP may intend to target those subscribers which do not presently subscribe to a premium level of service. The CSP may distribute a coupon to these select viewers allowing them to view programs they otherwise are unable to, and thereby incent the viewer to potentially upgrade their service. In order to accomplish this, the Coupon System must use the marketing or CSP data 616 to identify which viewers are targeted. In addition, CPRI data may also be used to generate the record, or may be stored within the coupon record. Because the coupon is generic to the program content, there is no need for any promotion data to identify any particular content the coupon can be redeemed towards.

The exact scope of a “generic” coupon with respect to content may have some limitations associated with the programming content. For example, the generic program may provide a discount to any PPV program on a local CSP. (Although this is limited to PPV, it is generic in the sense that it is not limited to only one particular PPV program.) However, once the coupon is tied to a particular PPV program title, then it is typically referred to as a “targeted” coupon with respect to the content. Similarly, a coupon can be limited to viewing of a premium channel and still be considered as “generic,” since it is not tied to a particular program. Further, the CSP may further limit application of a coupon. For example, even though a coupon is generic in the sense that it provides a discount to a PPV movie, a CSP involved in redeeming the coupon may further limit redemption to a specific set of titles, or exclude certain titles. Thus, even though a coupon record includes information that suggests the coupon is generic with respect to content, a CSP can limit application of the coupon, and effectively make the coupon content limited or specific.

The last type of coupon record structure is shown in step 618. This is a viewer generic/content generic coupon. Because this does not target any particular viewer or content, no data is required to target a particular viewer nor is any promotional information required to identify any particular content. Typically, the CSP involved in redeeming such a coupon may chose to further limit application of the coupon to certain content.

The particular process used in steps 608, 612, 616, and 618 can vary, and those skilled in the art can readily define further algorithms for forming the records and the structure of the records. In the various combinations above, even if no viewer specific or content specific requirements for the coupon record are included in the coupon record, further information may be included in the coupon record. In various other embodiments, other information is typically provided with the coupon, and these fields are identified below.

### Coupon Record Structure

The coupon generation process typically results in creating a set of records in a database. The coupon records are typically indexed by coupon code, and each record comprises the following fields. In many embodiments, certain fields are optional, and their presence is dependent on whether the information is required based on the type of record being created. FIG. 9 illustrates one possible structure with certain type of fields, and such a data structure can be used to indicate other fields as indicate below. For example, if the coupons are generic to the subscriber, then it is not necessary in all embodiments to include couponee information. However, if the coupon is specific to a subscriber, then typically some viewer identification information is included and it may be possible to incorporate that viewers CPRI data in the coupon record. Other structures of the record can be used and the following represents one embodiment.

The following fields can also be used as qualifiers in validating a request comprising a coupon code and a program identifier. Other information may be provided in conjunction with the validation query. The contents of the query are then compared with the various qualifiers in the corresponding coupon record to ensure that the redemption request of the movie is compatible with the coupon code data.

Coupon Code. The coupon code is the value entered by the user to redeem the coupon. Typically, this is also the coupon identification number used to index the coupon in the coupon file. The coupon code value and structure may vary, and in one embodiment this is a 10 digit number. Other embodiments may use few or more digits, and may use alphanumeric symbols as well. In some embodiments, the records are indexed by the coupon code, and the coupon code file comprises a series of records indexed on sequentially determined values.

Viewer Identifier. This is information identifying the viewer, which can be the same data as that identifying the Couponee (e.g., the viewer redeeming the coupon or the person receiving the coupon when distributed). This information could comprise the viewer's name and address, phone number, email address, etc. In other embodiments, the CSP may provide an account number. In some embodiments the field is populated when the coupon file is generated, allowing the coupon to be targeted for distribution to that viewer. In other embodiments, this field is left blank when generating the coupon file and populated as the coupon is redeemed. This presupposes a mechanism for identifying the viewer redeeming the coupon. In other embodiment, the identification could include a set top box identifier, or other equipment identification.

CSP Identifier. The coupons may be generated for a particular CSP. The CSP identifier indicates the CSP that is accepting the coupon codes for redemption. This information is also typically used when verifying a coupon code redeemed by a subscriber. The CSP typically includes this identifying information when verifying the coupon code by initiating a query to the Coupon System, to ensure that the appropriate codes generated for the CSP are being used by the viewer and that CSP. Typically, the Coupon System may house coupon codes that are allocated for different CSPs. Thus, it is not sufficient to merely check at the Coupon System when redeeming a code whether the coupon code was previously generated, but the Coupon System must also check that the coupon code is being redeemed for the CSP that the coupon code was created for. In some embodiments the CPS Identifier field is populated when the coupon file is generated, allowing the coupon to be targeted for that CSP. In other embodiments, this field is left blank when generating the coupon file and populated as the coupon is redeemed, thereby indicating the CSP involved in redeeming the coupon code.

Expiration Date. The expiration date indicates the last day which the coupon code is valid. This ensures that once the coupon code is generated, the code does not have an infinite lifetime. However, this field is not always explicitly generated in all embodiments, as the expiration date can be linked or encoded in other ways. For example, the coupon code itself can have encoded therein an expiration date or the code can be linked with another file which indicates the expiration date.

Use Indicator. The coupon code typically has a limited number of uses associated with it, which, in one embodiment, is a single use. This value can be maintained as a prior use flag in the coupon record that is updated as the coupon is used. In other embodiments, a coupon may have a limited number of uses greater than one. For example, a single code can be published allowing the first 50 users to receive a view a program without charge. It is still possible to have multiple codes with multiple uses, so that multiple groups comprising the first 50 users can redeem the coupon codes. In other embodiments, a single user could use the coupon code 50 times.

Distribution Channel. The distribution channel indicates which distribution channel was used to place the coupon code with the viewer. This allows tracking the relative effectiveness of the distribution channel. Thus, a CSP or Coupon System may initiate distribution of coupons using various distribution channels and the relative effectiveness can be compared after redemption.

Discount Level. The discount level indicates how much of a discount is to be provided. This can be indicated as a percentage or a flat fee. A flag can be used to indicate “free” or alternatively, the discount can be indicated as 100%.

Access Limits. This field may comprise data used to limit access to the programs in various ways. The redemption of a coupon may be restricted to use for certain types of programs, times, or other limitations. For example, a generic coupon entitling the viewer to a free PPV movie may exclude its application to “adult” rated movies. Thus, a rating indicator may be used to qualify redemption of a coupon code for viewing a program. The access limits can be indicated by inclusion (e.g., this coupon code is only redeemable for G or PG rated movies) or by exclusion (e.g., this coupon code cannot redeem R or Adult rated content). Other restrictions may prohibit using the coupon for certain other types of movies, such as those from a certain originator or distributor. Other access limits may allow the coupon to be used for only certain types of programs (e.g., a free movie from a certain program distributor) or certain times.

Targeted Content Identifier. This field may be used to identify a particular video program (e.g., a program identifier) which the coupon can redeem. This can be a numerical identifier, a program title, etc. This identifier may conform to a metadata asset identifier having a structure that is well known in the industry. The coupon system may use this field if the coupon is limited to being redeemed for a specific video program or content. In some embodiments the field is populated when the coupon file is generated. In other embodiments, this field is left blank when generating the coupon file and can be populated by a CSP before the coupons are redeemed, thereby allowing the CSP to define further limitations as to how the coupon can be redeemed on the CSP's system. In other embodiments, another party, such as a Promoter, may determine the value of this field.

Promoter Identifier. If particular content is being promoted, the promoter identifier may identify the promoter of the content to facilitate reconciliation of payments. For example, if XYZ Promoters is promoting a given movie, XYZ Promoters may provide reimbursement for each coupon redeemed. In some embodiments, the promoter identifier may be a content provider, or distributor of programming (e.g., HBO®). This can be used by the Coupon System to facilitate settling of accounts on a periodic basis.

The data in the coupon can also include the parameters indicated in FIG. 9, and described above. Various other data structures can be defined and still comport with the inventive principles.

### Coupon Distribution Process

The coupon distribution module executes a coupon distribution process. This process can occur in various ways, and hence the processing is highly dependent on the method selected. Further, distribution can occur by a distinct and separate system, so that this function can occur on another system platform, or by another entity. Some of the methods are described below:

Direct Distribution Via Email. The coupons can be electronically transmitted to viewers via email. In this case, the coupons can be associated with specific viewers, in which case the viewer's email is correlated with the type of coupon. Alternatively, the coupons can be viewer generic. However, even if the coupon is viewer generic, the Coupon System can email the coupon to specific viewers, but the coupon file does not store any information about the specific viewers receiving the coupon. Typically, the coupons are mailed to subscribers associated with particular CSPs (or thought to be subscribers of the CSP), but this is not always required. Generally, coupons are not intentionally sent to individuals that known in advance to be unable to redeem the coupons (e.g., sending the coupon to a non-subscriber of a cable system). In Direct Distribution Via Email, the Coupon System or another email server system can originate the email to the viewers.

Direct Distribution Via Third Party Direct Mailers. The coupon data can be provided to a third party direct mailer, who can print coupons and insert them in various direct mail marketing pieces. Again, the coupons can be tailored to a specific viewer or type of viewers (meaning information is retained in the coupon file these aspects), or the coupons can be generic to the viewer. In this distribution type, an electronic file is typically transferred to the direct mail marketer where they perform the further distribution steps.

Indirect Distribution Via Web Site. The Coupon System may provide a third party web site with the coupon file. The web site then allocates a coupon to a viewer visiting the web site (which can occur via clicking on an Internet ad in another web site). The coupon records are typically generic to a subscriber, since the identity of the visitor to the web site is typically not known. However, the web site may verify that the visitor is a subscriber of a particular CSP, or otherwise obtain the identity of the subscriber and then record that information in the coupon file (or transmit the information to the Coupon System to be stored in the coupon file). In some instances, the web site may prompt the visitor for information, such as their name or other information to ensure that the coupon is appropriate for the viewer (e.g., compatible with the visitor's CSP).

Indirect Distribution Via Third Party Merchant. The Coupon System may create a coupon file and transmit the file to a third party Merchant. The Merchant may then process the file in conjunction with their loyalty rewards system to then create the appropriate coupons.

For example, a CSP may desire to enter into a cross promotional arrangement with a grocery store chain that is located in the CSP's serving area. The CSP arranges for 10,000 coupon codes to be generated and provided to the grocery store chain. The grocery store chains provides the coupon (printed on the grocer's receipt) at checkout for each shopper purchasing over $100 in groceries. Thus, the Merchant is provided with the coupon codes and the program content information, and determines which of its customers can receive the coupon. It is possible that a coupon may be provided to a grocery shopper that is not a CSP customer. Thus, this form of distribution occurs indirectly by a third party Merchant allocating the coupons.

In the above scenarios, it is possible that further information may be added, obtained, or otherwise recorded in the coupon file during distribution of the coupons by the distributor. In such cases, the system doing so (if not the Coupon System) may transmit the altered Coupon File back to the Coupon System, so that the Coupon System can maintain a current and complete coupon file. In one embodiment, the Merchant can then add any CPRI with the Coupon File, and return the coupon file to the Coupon System, thus allowing the Coupon System to associate the CPRI with the coupon code upon redemption. In other embodiments, the Merchant can transmit the information to the Coupon System allowing the Coupon System to update the file.

Maintaining an indication of a Merchant associated with the distribution of the coupon, along with information associated with the viewer's purchasing habits, allows the CSP during redemption of the coupon to select an appropriate and effective ad for the viewer to see.

### Coupon Redemption Process

Coupon redemption refers to the processing associated with a viewer redeeming a coupon for viewing a program. Referring briefly to FIG. 3, the redemption process involves the CSP 300 receiving a redemption request, to which the CSP 300 initiates, in one embodiment, a query to the Coupon System 100 to validate the coupon code. If the Coupon System 100 validates the code, then the CSP provides the requested program. The CSP may receive various CPRI associated with the coupon in the coupon file when receiving the validation response, thus allowing the CSP to select the appropriate ad to stream to the viewer.

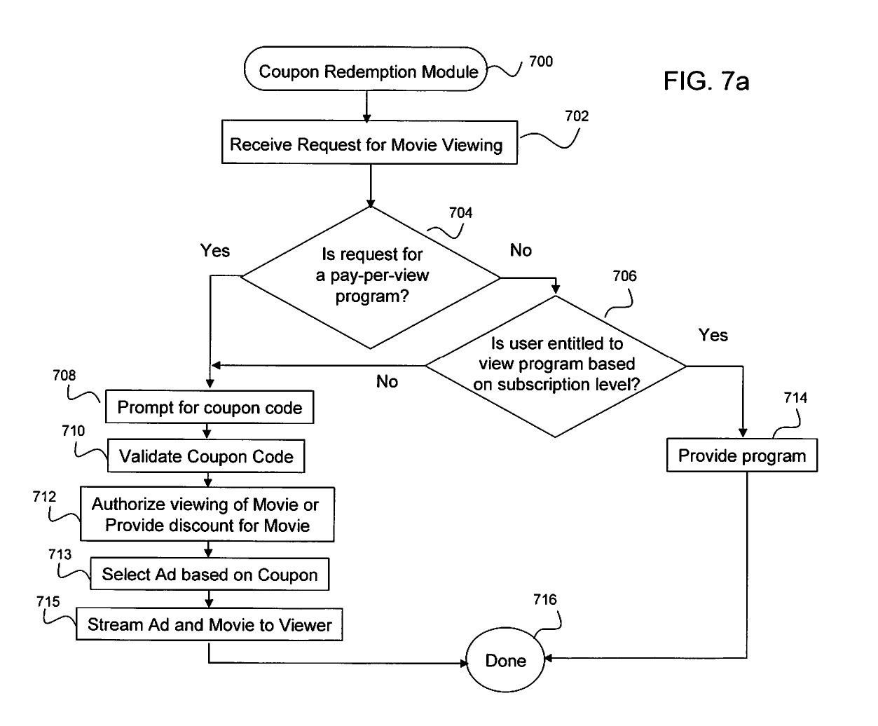

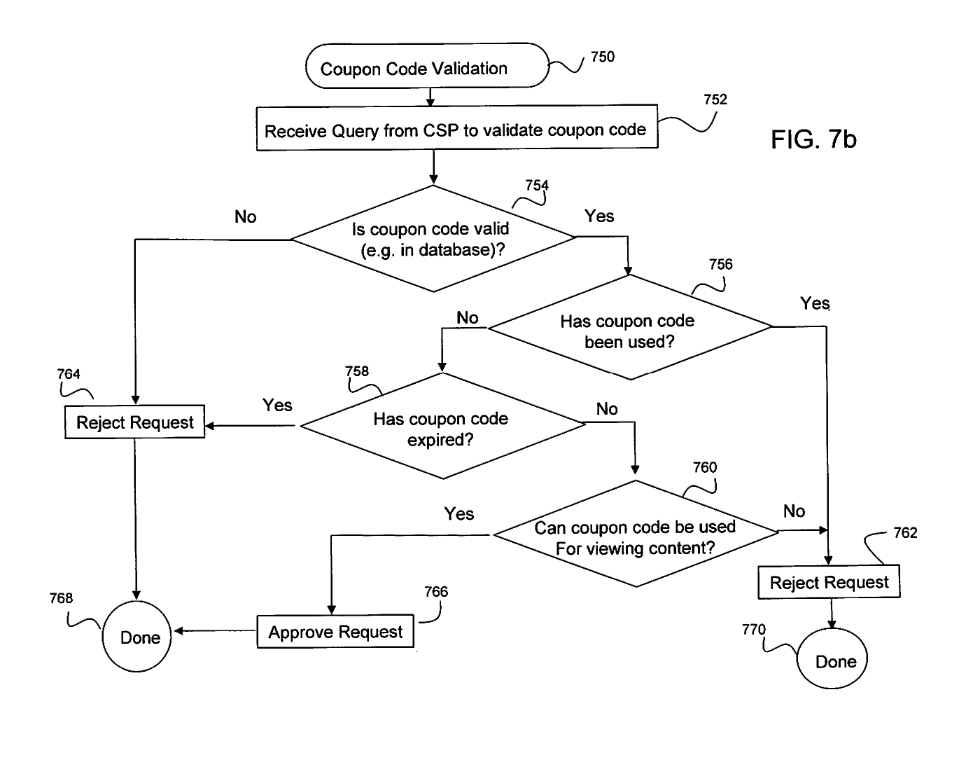

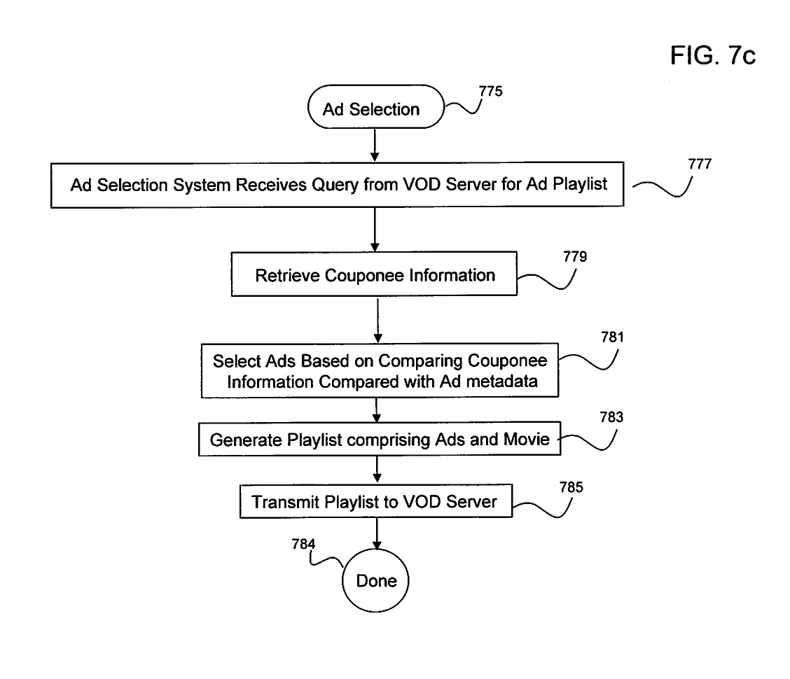

FIG. 7a illustrates one embodiment of the redemption processing associated with the CSP. In FIG. 7a, the process 700 begins with the CSP receiving a request for viewing a movie 702. This request typically is based on existing procedures for invoking a program request, such as using existing VOD or PPV procedures. The CSP tests if the request is for a PPV program at step 704. If the program is a PPV, then the CSP proceeds to step 708 for prompting the user for a coupon code. If the program is not a PPV program, then the CSP tests if this is for a program that the user is entitled to receive based on their subscription level. If it is, then step 714 is performed, which provides the program to the user as they are entitled to view it. However, if the user is not entitled to view the program based on their subscription level, then the CSP will proceed to step 708 where the viewer is prompted for a coupon code. The coupon code is typically not prompted for if the user already has access to the program via the user's subscription level. Various other tests can be defined, and not all embodiments are required to have the same set of tests.

The viewer will respond with the coupon code, which in one embodiment is an alpha-numeric set of digits. In this embodiment, it is a numeric code of a certain number of digits which are entered by the viewer using the remote controller. The CSP in step 710 validates the code. Typically, this is accomplished by initiating a query to the Coupon System 100. This query can be formatted to any protocol, and typically would include information such as:

a. CSP service provider identification,

b. Identification of the program being requested,

c. Rating of the program being requested, and

d. Coupon code entered by viewer.

Other information may be included, such as identification of the subscriber making the request, time of the request, or other meta-data associated with the requested program. This meta-data can conform to industry standards for video program meta-data. It should be noted that the information included in the query may vary in each embodiment. For example, some embodiments may provide identification of the program being requested (e.g., a program identifier), and the Coupon System could then ascertain the rating of the program being requested based on the program identifier to ensure that the coupon can be used for that program type. The Coupon System could use the program identifier to identify a meta-data file associated with it, which comprises information about the content provider or distributor, rating, and other information. In other embodiments, the program identification and rating may not be included, as the Coupon System may not use this information to compare against qualifier information stored in the coupon system. Thus, at the minimum, the coupon code would have to be provided, but beyond that, other information included may vary.

In some embodiments, some of the validating steps may occur in the Coupon System, with other validating steps occur in another system. For example, the Coupon System may receive a query from a CSP, and perform certain validation steps. Then, assuming these steps pass validation, the Coupon System may initiate a query to another system for additional validation. More specifically, the CSP may originate a query to the Coupon System indicating a coupon code, a program identifier, and CSP identifier. The Coupon System may receive the query and determine that the coupon code must be further validated by a promoter or content distributor, which has promoted that particular program. Thus, the Coupon System may initiate another query to another system and when receiving a response validating the information, only then respond to the CSP original's request. This type of architecture can be viewed as a distributed Coupon System. This allows a promoter to coordinate validation and redemption of coupon codes, which avoids the reliance on a single validation source. Thus, the promoter's system (which may appear as a duplicate of the Coupon System) may also process and regulate redemption of coupon codes.

The CSP receives a response from the Coupon System, which will indicate that the request is either accepted or rejected (not shown in FIG. 7a). If the request is rejected, then the CSP will inform the user that the coupon is not valid. Assuming the request is granted, then in step 712, the CSP authorizes viewing of the program or appropriate discounts are taken if the program is a PPV. Typically, the response from the Coupon System will indicate a discount level so that the CSP can indicate the appropriate discount for that subscriber. Typically, the CSP will also inform the viewer that the coupon code is valid, and the discount that is to be applied.

The CSP then determines which ad or ads to select with the streaming of the program. Typically, the VOD Server queries an Ad Server, indicating associated information with the redemption request. Specifically, the VOD Server may include in its query the program to be played, meta-data regarding the program, and the CPRI. The Ad Server can then determine based on this information which ad should be selected from the inventory of advertisement assets in step 713. This may include selecting a pre-roll, mid-roll, and post-roll ad, or any other number of ads. This information is returned to the VOD Server in what is called a “playlist” and then the VOD server streams the appropriate ad and movie assets as indicated in step 715. The process then completes in step 716.

Note that there are other embodiments which are possible. For example, the VOD Server could inform the Ad Server of the program, coupon code, and Merchant identifier, so that the Ad Server could then query a separate database, such as a database operated by the Merchant, to retrieve CPRI information or data generated therefrom. Alternatively, the Ad Server could query the Merchant's database indicating the coupon code, and the Merchant could return a suggested advertising asset identifier. Thus, one skilled in the art will readily determine a number of variations are possible. Alternatively, the various functions of the servers could be integrated into a single computer system.

One embodiment of the processing occurring in the Coupon System receiving the validation request is shown in FIG. 7b. In FIG. 7b, the process 750 begins with the Coupon System receiving a query from the CSP for validating a coupon code 752. In step 754, the Coupon System 100 determines if the coupon code is stored in the coupon file in the database. The system must take into account that a viewer may be entering a coupon code merely as an attempt to a guess a valid code, reflecting a mere attempt by a subscriber to obtain an authorized discount. Hence, the coupon code identifier number should be validated, as it may not even be in the system database. Assuming the number does correspond to a coupon record, the coupon record is retrieved and the Coupon System then determines if the limit of use of the coupon has been reached in step 756. Assuming the limit has not been reached, then processing next tests in step 758 whether the coupon code has expired. Assuming the coupon code has not expired, then the Coupon System next test in step 760 whether there are any restrictions regarding use of the coupon code for the requested program. The code may be limited for redemption for a specific movie, or type of movie. Thus, a code promoting “Movie X” cannot be used for obtaining a discount for “Movie Y.” Other examples include restricting use of a coupon code for certain types of programs based on rating, such as “adult” or “R” rated programs. Other restrictions can be defined. Thus, any of the fields in the coupon record comprises qualification data that can be used to validate the redemption request.

Assuming that all appropriate tests have passed, the Coupon System approves the request in step 766. This involves sending a response to the CSP, which also typically indicates the discount level (if appropriate) to be provided to the viewer. The Coupon System also will note that the coupon has been used (redeemed), and this can be indicated by setting a flag or incrementing a counter in the coupon code record. The Coupon System may also note in the coupon record the CSP initiating the request, date, time, couponee, or other information. Such information can be used to analyze the redemption requests to obtain market intelligence. If any of the tests at step 754, 756, or 760 fail, then the system proceeds to steps 764 or 762 as appropriate, which rejects the request and sends an appropriate response to the CSP.

The nature and order which the steps that are performed can vary, and the type of test performed can vary as well. The Coupon System may perform other tests, such as testing whether the CSP is approved to make requests. The Coupon System may also receive information regarding the subscriber's identity and determine whether the viewer is entering too many coupon codes. Thus, additional fraud prevention or other limiting tests can be performed. Thus, FIGS. 7a and 7b illustrate only one type of embodiment of the processing that may be performed.

### Ad Selection Process

One embodiment of the process executing in the Ad Server 775 is shown in FIG. 7c. The process begins in step 777 with the Ad Selection system receiving a query from the VOD Server for a playlist. The query may include CPRI information, and/or the query may include the coupon code, and the Ad Selection system then obtains the CPRI by in step 779 by accessing a local copy of the coupon file, or initiating another query to an external database storing the coupon file or a portion thereof.

In step 781, the CPRI is used to select the advertising asset. There are various algorithms that can be used, and two examples are provided. In the first example, the merchant identifier associated with the coupon code is used to select any one of the advertising assets associated with that Merchant. For example, if the coupon code is associated with a brand of gasoline filing station, then an advertisement for that gasoline brand will be selected. Thus, the merchant identifier is used to select a set of ads for that Merchant. Once the set is identified, then an ad can be selected by random, by a round-robin list, or by selecting the ad that has been played the least number of times. Other variations are possible.

The second example involves using both the merchant identifier and product purchasing history to select the ad. For example, the merchant identifier can be used for identifying a set of ads (as described above). Then, a particular ad in the set could then be selected by the customer's product purchasing history. Suppose that the Merchant is a department store that sells a variety of products including children's toys as well as clothing. The selection of the ad can be based on the purchasing history. The Merchant may have recorded that the Couponee purchases a large number of children's toys, and on that basis, a particular ad from the set of ads could be selected (e.g., an ad is selected that focuses on children's toys as opposed to apparel). If the product purchasing history does not sufficiently identify an individual ad, then the set of ads can be further narrowed down in a number of ways as described above (e.g., the Merchant may have two ads directed to children's toys).

Those skilled in the art will realize that once the CPRI is known, that additional granularity can be offered in selecting a more tailored ad for the Couponee during the redemption process.

### Illustrative Example

One embodiment of the invention is provided below and is based on a co-marketing arrangement between a grocery store chain and a CSP. In this arrangement, the grocery store has a “frequent shopper” program that rewards frequent shoppers. Shoppers are usually identified at checkout by providing a membership card (which is bar-coded with a customer identification number and scanned). Thus, the grocery store tracks each shopper's purchase, and allocates a reward based on some criteria. In this embodiment, the reward involves a coupon for a free pay-per view movie (excluding adult movies) that is provided to shoppers whose bill exceeds $100. Such shoppers are considered “gold-level” shoppers by the grocery store.

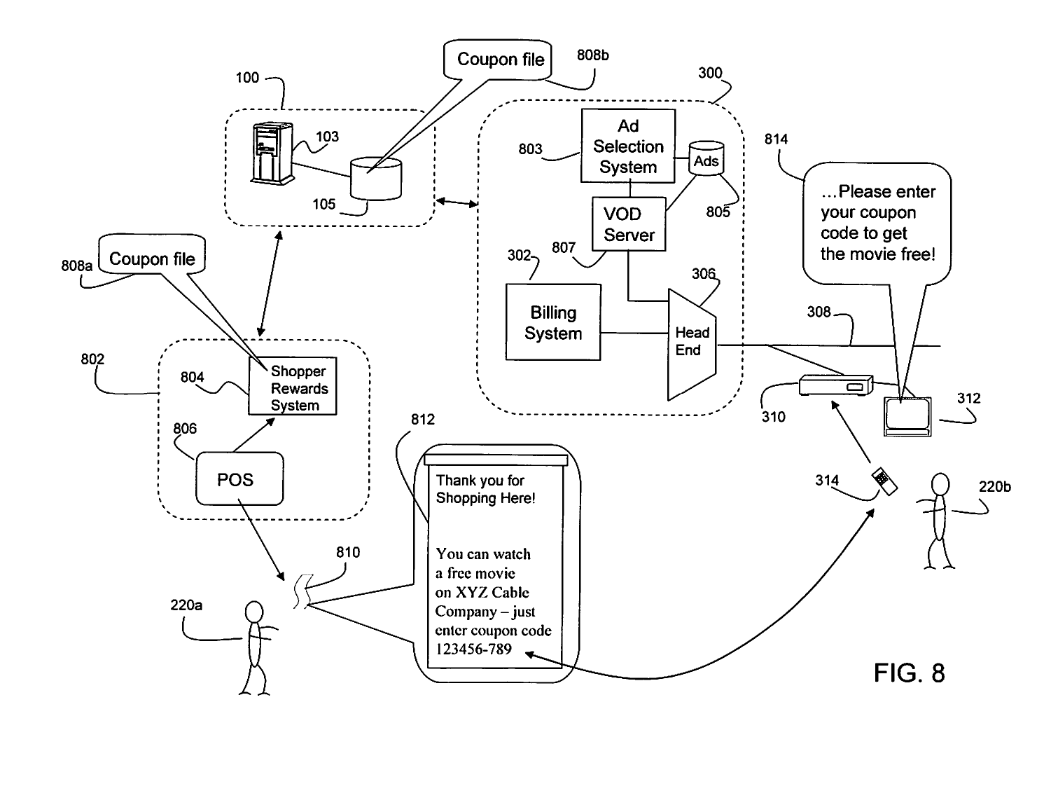

This example can be illustrated with the aid of FIG. 8. In FIG. 8, the shopper 220a is at the grocery store and interacts with the grocery stores business systems 802, which comprises a point-of-sale (POS) system 806 that performs the traditional check-out functions. As part of check-out, the POS system 806 interacts with a shopper rewards system 804 that stores information about the shopper, their purchases, and can dynamically select and print out coupons on the sales receipt 810. The shopper rewards system 804 is presumed to have an “inventory” of coupons codes in a coupon file 808 stored in the shopper rewards system 804 to allocate as it determines appropriate. The shopper rewards system 804 previously obtained the file 808 from the Coupon System 100, before distribution of the coupon codes to the shoppers. Because various systems are involved, the promotional program must be coordinated between the Merchant, the Coupon System, and the CSP in advance of distribution of the coupons to the viewers.

When the shopper completes check-out, a receipt 810 is provided to the shopper. As is well known, the POS cooperating with the Shopper Rewards System 804 can dynamically print a coupon on the shopper's receipt. In this case, a coupon 812 is printed on the bottom of the receipt informing the shopper that a free pay-per-view movie can be redeemed from the XYZ Cable Company by entering the indicated coupon code.

The Shopper Rewards System 804 then updates the Coupon System 100 with information, including which coupon codes were distributed to which shoppers, and various CPRI about the Couponee. For purposes of this illustration, the Merchant informs the Coupon System that the allocated coupon code is associated with a “gold level” shopper. Thus, in this embodiment, the Coupon System updates the coupon file to have the appropriate CPRI information.

The shopper 220b then returns to their house where they receive cable service from the XYZ cable service provider, and invokes a PPV program request using existing PPV procedures. This is accomplished using a remote controller 314, the input of which is processed by STB 310. In some embodiments, an appropriate software program may be downloaded to the STB to modify processing of user requests for PPV programs in order to recognize and prompt the viewer for a coupon code. The prompt 814 can be displayed as a menu option on the television 312 that the viewer sees.

After entering the coupon code from the receipt, the information is sent to the STB and to the CSP 300 wherein a query is sent to the Coupon System 100 to determine if the code is valid. The validation involves the billing system initiating a query to the coupon system 100, which is received by the processor 103. The processor validates the coupon code by retrieving the appropriate coupon record as indexed by the coupon code from a coupon file database 105. The Coupon System 100 determines if the code is valid, if it has been used before, and whether the coupon code has expired. The Coupon System may also check to ensure that the program request is compatible with restrictions associated with the coupon code. For example, if the agreement between the grocery store and the CSP is to exclude using the coupon for adult movies, the Coupon System may check the requested program's rating against restrictions indicated in the database 105. Of course, the CSP will have to include this information in the query to the Coupon System.

Assuming these and any other tests are passed, the Coupon System responds to the CSP by affirming the coupon code is valid, and further indicating a discount level to the billing system 302. The Coupon System may also include in the response information identifying the Merchant that gave out the coupon, and other CPRI, which indicates the Couponee is a “gold level” shopper. The CSP's billing system will provide an appropriate discount to the viewer's account and then instructs the VOD server 807 to proceed in fulfilling the redemption request.

Next, the VOD Server 807 initiates a query to the Ad Selection system 803 as to what ads should be incorporated into the playlist. The query may indicate the movie selected, and the certain CPRI. In this example, the merchant identifier and shopper status is conveyed to the Ad Selection System. In other embodiments, the VOD Server may convey the coupon code, and the Ad Selection system 803 will use the coupon code to query a database with the coupon file to obtain the CPRI.

The Ad Selection system knows what ad assets are available in an attached data store 805, and selects the ad(s) based on the merchant identifier and the shopper level. For example, the ads in the Ad Server may comprise ads for automobile dealers, airlines, medical practices, various grocery stores, etc. The indication in the query of the merchant identifier (e.g., a particular grocery store chain) results in the Ad Selection system selecting ads that feature the grocery store chain. In this embodiment, there may be multiple ads stored in the Ad Selection system database 805 for that Merchant. Assume there is 1) a first ad marketing the economical, low cost of fruits and vegetables available at the grocery store, and 2) a second ad featuring the high quality, and more expensive, products of the grocery store. Since the coupon code is associated with a Couponee that is a “gold level” shopper, the algorithm can be defined to select the second ad whenever a “gold level” viewer is indicated, in order to encourage that viewer to spend even more money when shopping in that grocery store in the future. The algorithm may be determined by cooperation between the Coupon System and the Merchant. Those skilled in the art will recognize that a variety of rules can be defined as to how the CPRI can be used to select an ad.

The Ad Selection system then returns the ad selection information back to the VOD Server 807, and the VOD server streams the program over the cable distribution network 308 to the STB 310, where it is displayed on the television 312.

The coupon codes in the coupon file 808a (which in one embodiment can also be stored in a coupon file 808b in database 105) are allocated by the grocer to any shopper purchasing over $100 in groceries and are redeemable for any type of PPV or other program on their local cable service provider. Of course, this presumes that the grocer's reward processing system, Coupon System, and CSP have established the necessary agreements for cross promotional marketing and appropriate interaction. Although FIG. 8 discloses the Coupon System 100 serving a single grocer 802 and a single CSP 300, it is quite possible for multiple Merchants (and of different types) to be supported by the Coupon System, as well as multiple CSPs. Thus, a Coupon System may have arrangements with multiple CSPs serving a geographical area, so that any coupons provided by the grocer in different cable service areas are redeemable by the shoppers, regardless of which CSP serves the shopper. Further, it is possible for the Coupon System to serve multiple merchants. Thus, a CSP desiring to promote a program, could make arrangements with various merchants in their serving area allowing coupons to reach subscribers associated with different Merchants (e.g., via grocery stores, gas stations, convenience stores, ticket agencies, restaurants, etc.). In some embodiments, because coupon code ranges can be assigned to different Merchants, the usage of coupons codes can be tracked as to how/where/when/and by whom the coupon codes are redeemed.

In an alternative embodiment, the coupon distributed to the shoppers can be considered as a “generic subscriber” and “generic program” coupons. In this case, there may not be any indication of a particular subscriber's purchasing habits (because there is no particular subscriber that the coupon is associated with), but the coupon code can still be associated with a specific Merchant, and that could be used to select ads associated with that Merchant.

In other embodiments, the Coupon System could associate the coupon code with redeeming only a specific movie. Thus, a promoter of a specific movie could arrange with the grocery store and the CSP to promote a specific movie. In this case, the query from the CSP indicates the requested program, and the Coupon System 100 checks that the code is being used for the appropriate program content. Thus, this would be a “generic subscriber” and “targeted program” type of coupon. In this case as well, the coupon code can be used to ensure that only ads for that participating Merchant would be selected for viewing.

In the above embodiment, the Coupon System 100 could be owned by the CSP, the grocery store, or a third party. In particular, the systems could be geographically located in different locations, such that a LAN, WAN, or the Internet (not shown) can be used to provide communication between these systems. In other embodiments, the Coupon System 100 can be integrated with the Billing System 302, or otherwise co-located with the CSP. Further, in other embodiments, the functionality of the Coupon System 100 could be integrated with the shopper rewards system 804. Thus, although FIG. 8 illustrates one embodiment of the physical architecture, other variations are possible.

Those skilled in the art will recognize that many variations of the present invention are possible, than what is disclosed herein. Instead of a grocery shopper reward system, a frequent flyer reward system could be implemented. In other embodiments, electronic coupons could be distributed in conjunction with using a charge card, printed in portions of products (e.g., inside bottle caps or labels), or provided on printed cards as a promotional mailing.

That which is claimed:

1. A system for selecting an advertisement to stream with a selected video program by a video service provider to a viewer, said system comprising:
a) an ad selection system comprising:
a first processor configured to perform the steps of:
i) receive a request for one or more advertisements to be provided to said viewer, said request comprising a coupon code identifier, wherein said coupon code identifier is received from a distribution network connected to a customer premise video processing equipment operated by said viewer,
ii) use a merchant identifier associated with said coupon code identifier to select said advertisement from among a plurality of advertisements,
iii) generate a playlist comprising a first digital video file identifier identifying said advertisement, and
iv) transmit said playlist;
b) a video delivery server comprising:
a second processor configured to receive said playlist, and cause said advertisement and said selected video program to be streamed to said viewer; and
c) a database storing said advertisement as a first digital video file and said selected video program as a second digital video file, said database configured to stream said advertisement and said video program to said viewer.

2. The system of claim 1 further comprising a coupon system, wherein said first processor is configured to query said coupon system to determine said merchant identifier.

3. The system of claim 2 wherein said first processor is configured to further use CPRI data to select said advertisement from among said plurality of advertisements.

4. The system of claim 3 wherein CPRI data includes a product related identifier, and wherein said first processor is configured to use said product related identifier to select said advertisement.

5. The system of claim 1 wherein said first processor is configured to generate said playlist comprising said first digital video file identifier as a pre-roll advertisement and a second digital video file identifier as a mid-roll advertisement.

6. The system of claim 1 further comprising:
a coupon system comprising:
a coupon system processor configured to perform the steps of:
i) receive said coupon code identifier,
ii) retrieve a coupon record in a coupon file, said coupon record comprising said CPRI,
iii) provide at least a subset of said CPRI or data derived therefrom to said ad selection system; and
a second database comprising said coupon file, further comprising a plurality of coupon records.

7. The system of claim 6 wherein said coupon system is capable of receiving CPRI data provided from a merchant system.

8. The system of claim 1 wherein said first processor is configured to use said coupon code to identify a coupon record in a coupon file, and retrieve a couponee identifier, wherein said first processor is configured to use said couponee identifier in selecting said advertisement.

9. A method for a video service provider to stream an advertisement and a selected video program to a viewer of a video service provider comprising the steps of:
receiving a coupon code transmitted to said video service provider, said coupon code entered by said viewer for redemption in conjunction with viewing said selected video program;
accessing a coupon record in a coupon file, said coupon record comprising said coupon code and a merchant identifier;
using said merchant identifier by a processor in an ad selection system to generate a playlist comprising at least one video file identifier associated with said advertisement;
transmitting said playlist from said processor to a video delivery server;
streaming said advertisement over a video distribution network followed by said selected video program by said video delivery server to said viewer.

10. The method of claim 9 wherein said processor selects said advertisement from a plurality of advertisements, wherein said advertisement is associated with said merchant identifier.

11. The method of claim 10 wherein said coupon record comprises Customer Purchasing Related Information (“CPRI”) data, and said processor selects said advertisement from a plurality of advertisements further using CPRI data wherein said CPRI data comprises product related data.

12. The method of claim 11 wherein said coupon file is stored in a coupon system comprising a first database storing a plurality of coupon records, and further comprising a video delivery server comprising a second database storing a plurality of video files comprising said advertisement and said selected video program.

13. The method of 12 further comprising the steps of:
receiving by said processor a query from said video delivery server for said playlist;
initiating a query from said processor to said coupon system, said query comprising said coupon code; and
receiving at least one of said merchant identifier or said CPRI data from said coupon system.

14. The method of claim 9 wherein said coupon file further comprises an expiration date in said coupon record, and a second processor determines that said coupon can be redeemed based on said expiration date having not yet occurred.

15. A computer readable medium comprising instructions causing a processor to perform the steps of:
i) receive a request from a video delivery server for a playlist comprising one or more advertisements to be provided to said viewer in conjunction with a viewer selected video on demand program, wherein said request further comprises a coupon code;
ii) initiate a query to a memory store comprising a coupon file wherein said coupon file comprises a plurality of coupon records, wherein each coupon record is indexed by a coupon identifier number;
iii) receive a merchant identifier in response to said query, wherein said merchant identifier is stored in a coupon record indexed by said coupon code;
iv) select a first advertisement video file identifier to include on said playlist wherein said first advertisement video file identifier identifies an advertisement associated with a merchant identified by said merchant identifier; and
v) transmit in response to said request said playlist comprising said first advertisement video file identifier.

16. The computer readable medium of claim 15 further comprising the step of:
receiving CPRI data along with said merchant identifier in response to said query, wherein said first advertisement video file identifier is selected based on, in part, using said CPRI data.

17. The computer readable medium of claim 15 wherein selecting said first advertisement video file identifier comprises selecting a first video file identifier as a pre-roll ad and selecting a second video file identifier as a mid-roll ad, and said playlist comprises said first video file identifier and a second video file identifier.

18. The computer readable medium of claim 16 wherein the CPRI data comprises product related information.

19. The computer readable medium of claim 15 wherein said coupon record comprises an expiration date data, and further comprising the step of determining said coupon can be redeemed based on said expiration date not yet having occurred.

20. The computer readable medium of claim 15 wherein the step of selecting a first advertisement video file identifier is based on couponee information.
